(19) United States
(12) Patent Application Publication
(10) Pub. No.: US 2024/0310707 A1
(43) Pub. Date: Sep. 19, 2024

(54) LASER PROJECTION APPARATUS

(71) Applicant: HISENSE LASER DISPLAY CO., LTD, Qingdao (CN)

(72) Inventors: Wei LI, Qingdao (CN); Youliang TIAN, Qingdao (CN); Xianrong LIU, Qingdao (CN); Xiaoqiang GU, Qingdao (CN)

(73) Assignee: HISENSE LASER DISPLAY CO., LTD, Qingdao (CN)

(21) Appl. No.: 18/615,734

(22) Filed: Mar. 25, 2024

Related U.S. Application Data
(63) Continuation of application No. PCT/CN2022/121689, filed on Sep. 27, 2022.

(30) Foreign Application Priority Data
Sep. 27, 2021 (CN) 202111136139.5
Sep. 27, 2021 (CN) 202111137261.4
Sep. 27, 2021 (CN) 202111138946.0

(51) Int. Cl. G03B 21/20; G02B 26/00; G02B 27/14

(52) U.S. Cl. CPC G03B 21/204; G02B 26/008; G03B 21/2066; G03B 21/208; G02B 27/14

(57) ABSTRACT

A laser projection apparatus includes a laser source assembly, a light modulation assembly, and a projection lens. The laser source assembly includes a laser device, a microlens array, a combining component, and a phosphor wheel. The microlens array is configured to increase divergence angles of the plurality of laser beams in a slow axis direction and a fast axis direction, so as to make a ratio of divergence angles of the laser beams diverged by the microlens array in the slow axis direction and the fast axis direction be proportional to a length-width ratio of the light inlet of the light pipe. The combining component is configured to reflect laser beams and a fluorescent beam exiting from the phosphor wheel and transmit the plurality of laser beams emitted by the laser device. The phosphor wheel is configured to reflect the laser beams and be excited to emit the fluorescent beam.

### CROSS-REFERENCE TO RELATED APPLICATIONS

This application is a continuation application of International Patent Application No. PCT/CN2022/121689, filed on Sep. 27, 2022, which claims priority to Chinese Patent Application No. 202111136139.5, filed on Sep. 27, 2021; Chinese Patent Application No. 202111137261.4, filed on Sep. 27, 2021; and Chinese Patent Application No. 202111138946.0, filed on Sep. 27, 2021, which are incorporated herein by reference in their entireties.

### TECHNICAL FIELD

The present disclosure relates to the field of laser projection technologies and, in particular, to a laser projection apparatus.

### BACKGROUND

With the continuous development of sciences and technologies, laser projection apparatuses are increasingly applied in work and life of people. At present, the laser projection apparatus projects projection beams onto a projection screen, and the projection screen reflects the projection beams, so as to display a projection image. Moreover, with the development of laser projection technologies, consumers have higher and higher requirements for the miniaturization of the laser projection apparatus.

### SUMMARY

In an aspect, a laser projection apparatus is provided. The laser projection apparatus includes a laser source assembly, a light modulation assembly, and a projection lens. The laser source assembly is configured to provide illumination beams. The light modulation assembly is configured to modulate the illumination beams, so as to obtain projection beams. The light modulation assembly includes a light pipe configured to receive the illumination beams provided by the laser source assembly and homogenize the illumination beams. A light inlet of the light pipe is in a shape of a rectangle. The projection lens is configured to project the projection beams into an image. The laser source assembly includes a laser device, a microlens array, a combining component, and a phosphor wheel. The laser device is configured to emit a plurality of laser beams. The microlens array is located on a laser-exit side of the laser device and configured to increase divergence angles of the plurality of laser beams in a slow axis direction and a fast axis direction, so as to make a ratio of a divergence angle of the laser beams diverged by the microlens array in the slow axis direction to a divergence angle of the laser beams diverged by the microlens array in the fast axis direction be proportional to a length-width ratio of the light inlet of the light pipe. An angle at which the microlens array diffuses the incident laser beams in the fast axis direction is different from an angle at which the microlens array diffuses the incident laser beams in the slow axis direction. The microlens array includes a first substrate and a plurality of microlenses arranged in an array on the first substrate. The combining component is located on a side of the microlens array away from the laser device. The combining component is configured to reflect laser beams and a fluorescent beam exiting from the phosphor wheel and transmit the plurality of laser beams emitted by the laser device. The phosphor wheel is located on a side of the combining component away from the microlens array. The phosphor wheel is configured to reflect the laser beams transmitted by the combining component and be excited to emit the fluorescent beam due to irradiation of the laser beams. The laser beams reflected by the phosphor wheel and the fluorescent beam emitting by the phosphor wheel are incident on the combining component and reflected to the light inlet of the light pipe by the combining component. The laser beams and the fluorescent beam incident on the light pipe constitute the illumination beams.

In another aspect, a laser projection apparatus is provided. The laser projection apparatus includes a laser source assembly, a light modulation assembly, and a projection lens. The laser source assembly is configured to provide illumination beams. The light modulation assembly is configured to modulate the illumination beams, so as to obtain projection beams. The light modulation assembly includes a light pipe configured to receive the illumination beams provided by the laser source assembly and homogenize the illumination beams. A light inlet of the light pipe is in a shape of a rectangle. The projection lens is configured to project the projection beams into an image. The laser source assembly includes a laser device, a microlens array, a combining component, and a phosphor wheel. The laser device is configured to emit a plurality of laser beams. The microlens array is located on a laser-exit side of the laser device and configured to increase divergence angles of the plurality of laser beams in a slow axis direction and a fast axis direction, so as to make a ratio of a divergence angle of the laser beams diverged by the microlens array in the slow axis direction to a divergence angle of the laser beams diverged by the microlens array in the fast axis direction be proportional to a length-width ratio of the light inlet of the light pipe. An angle at which the microlens array diffuses the incident laser beams in the fast axis direction is different from an angle at which the microlens array diffuses the incident laser beams in the slow axis direction. The microlens array includes a first substrate and a plurality of microlenses arranged in an array on the first substrate. The combining component is located on a side of the microlens array away from the laser device. The combining component is configured to reflect the plurality of laser beams emitted by the laser device and transmit laser beams and a fluorescent beam exiting from the phosphor wheel. The phosphor wheel is located on a side of the combining component. An arrangement direction of the phosphor wheel and the combining component is perpendicular to an arrangement direction of the microlens array and the combining component. The phosphor wheel is configured to reflect the laser beams reflected by the combining component and be excited to emit the fluorescent beam due to irradiation of the laser beams. The laser beams reflected by the phosphor wheel and the fluorescent beam emitted by the phosphor wheel are incident on the combining component and transmitted to the light inlet of the light pipe by the combining component. The laser beams and the fluorescent beam incident on the light pipe constitute the illumination beams.

### BRIEF DESCRIPTION OF THE DRAWINGS

FIG. 1 is a diagram showing a structure of a laser projection apparatus, in accordance with some embodiments;

FIG. 2 is a diagram showing a partial structure of a laser projection apparatus, in accordance with some embodiments;

FIG. 3 is a diagram showing a beam path of a laser source assembly, a light modulation assembly, and a projection lens in a laser projection apparatus, in accordance with some embodiments;

FIG. 4 is a diagram showing a principle of projection imaging by a laser projection apparatus, in accordance with some embodiments;

FIG. 5 is a diagram showing an arrangement of micromirrors in a digital micromirror device, in accordance with some embodiments;

FIG. 6 is a diagram showing another beam path of a laser source assembly, a light modulation assembly, and a projection lens in a laser projection apparatus, in accordance with some embodiments;

FIG. 7A is a schematic diagram of a beam spot at a light inlet of a light pipe in the related art;

FIG. 7B is a schematic diagram of a beam spot at a light inlet of a light pipe, in accordance with some embodiments;

FIG. 8 is a diagram showing a structure of a laser source assembly, in accordance with some embodiments;

FIG. 9 is a diagram showing a structure of a microlens array, in accordance with some embodiments;

FIG. 10 is a partial enlarged view of the box A in FIG. 9;

FIG. 11 is a diagram showing a structure of another microlens array, in accordance with some embodiments;

FIG. 12 is a schematic diagram of beam spots formed by laser beams passing through a microlens array, in accordance with some embodiments;

FIG. 13 is a diagram showing a structure of a combining component, in accordance with some embodiments;

FIG. 14 is a diagram showing a structure of another combining component, in accordance with some embodiments;

FIG. 15 is a diagram showing a structure of another laser source assembly, in accordance with some embodiments;

FIG. 16 is a diagram showing a structure of yet another laser source assembly, in accordance with some embodiments;

FIG. 17 is a diagram showing a structure of yet another laser source assembly, in accordance with some embodiments;

FIG. 18 is a diagram showing a structure of yet another combining component, in accordance with some embodiments;

FIG. 19 is a diagram showing a structure of a phosphor wheel, in accordance with some embodiments;

FIG. 20 is a diagram showing a structure of another phosphor wheel, in accordance with some embodiments;

FIG. 21 is a diagram showing a structure of yet another phosphor wheel, in accordance with some embodiments;

FIG. 22 is a diagram showing a structure of a driving component, in accordance with some embodiments; and

FIG. 23 is a diagram showing a structure of yet another laser source assembly, in accordance with some embodiments.

### DETAILED DESCRIPTION

Some embodiments of the present disclosure will be clearly and completely described below with reference to the accompanying drawings. However, the described embodiments are merely some but not all embodiments of the present disclosure. All other embodiments obtained by a person of ordinary skill in the art based on embodiments of the present disclosure shall be included in the protection scope of the present disclosure.

Unless the context requires otherwise, throughout the specification and the claims, the term “comprise” and other forms thereof such as the third-person singular form “comprises” and the present participle form “comprising” are construed as an open and inclusive meaning, i.e., “including, but not limited to.” In the description of the specification, the terms such as “one embodiment,” “some embodiments,” “exemplary embodiments,” “example,” “specific example,” or “some examples” are intended to indicate that specific features, structures, materials, or characteristics related to the embodiment(s) or example(s) are included in at least one embodiment or example of the present disclosure. Schematic representations of the above terms do not necessarily refer to the same embodiment(s) or example(s). In addition, the specific features, structures, materials, or characteristics may be included in any one or more embodiments or examples in any suitable manner.

Hereinafter, the terms such as “first” and “second” are used for descriptive purposes only and are not to be construed as indicating or implying the relative importance or implicitly indicating the number of indicated technical features. Thus, features defined by “first” or “second” may explicitly or implicitly include one or more of the features. In the description of the embodiments of the present disclosure, the term “a plurality of” or “the plurality of” means two or more unless otherwise specified.

In the description of some embodiments, the term “connected” and derivative thereof may be used. The term “connected” should be understood in a broad sense. For example, the term “connected” may represent a fixed connection, a detachable connection, or a one-piece connection, or may represent a direct connection, or may represent an indirect connection through an intermediate medium. The embodiments disclosed herein are not necessarily limited to the content herein.

The phrase “at least one of A, B, and C” has the same meaning as the phrase “at least one of A, B, or C,” both including the following combinations of A, B, and C: only A, only B, only C, a combination of A and B, a combination of A and C, a combination of B and C, and a combination of A, B, and C.

The use of the phase “applicable to” or “configured to” herein means an open and inclusive expression, which does not exclude devices that are applicable to or configured to perform additional tasks or steps.

The terms such as “about,” “substantially,” and “approximately” as used herein include a stated value and an average value within an acceptable range of deviation of a particular value. The acceptable range of deviation is determined by a person of ordinary skill in the art, considering measurement in question and errors associated with measurement of a particular quantity (i.e., limitations of a measurement system).

The term such as “parallel,” “perpendicular,” or “equal” as used herein includes a stated condition and a condition similar to the stated condition. A range of the similar condition is within an acceptable deviation range, and the acceptable deviation range is determined by a person of ordinary skill in the art, considering measurement in question and errors associated with measurement of a particular quantity (i.e., the limitations of a measurement system).

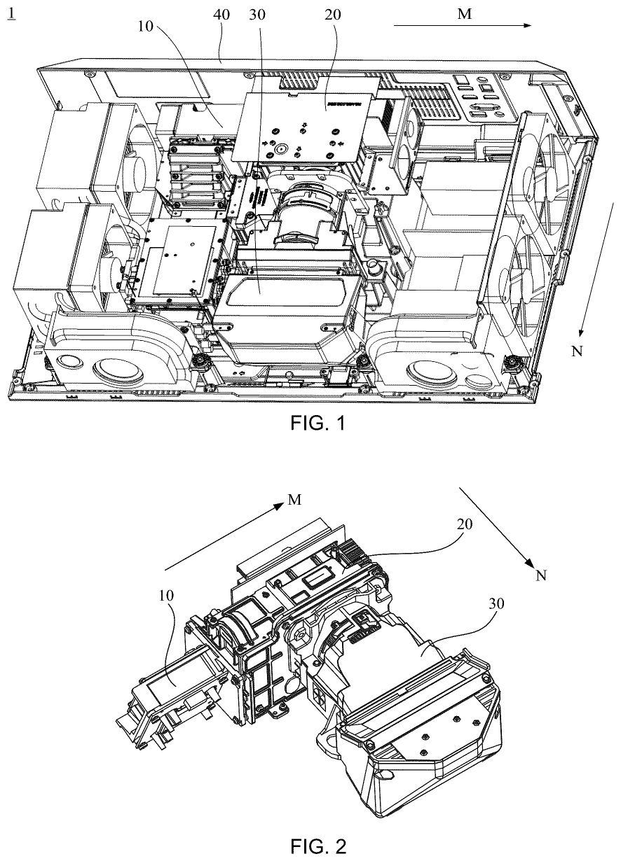

FIG. 1 is a diagram showing a structure of a laser projection apparatus, in accordance with some embodiments.

In some embodiments of the present disclosure, a laser projection apparatus 1 is provided. As shown in FIG. 1, the laser projection apparatus 1 includes an apparatus housing 40 (only a portion of the apparatus housing 40 being shown in FIG. 1), and a laser source assembly 10, a light modulation assembly 20, and a projection lens 30 that are assembled in the apparatus housing 40. The laser source assembly 10 is configured to provide illumination beams (e.g., laser beams and a fluorescent beam). The light modulation assembly 20 is configured to modulate the illumination beams provided by the laser source assembly 10 with image signals, so as to obtain projection beams. The projection lens 30 is configured to project the projection beams into an image on a screen or a wall.

FIG. 2 is a diagram showing a partial structure of a laser projection apparatus, in accordance with some embodiments.

As shown in FIG. 2, a first end of the light modulation assembly 20 is connected to the laser source assembly 10, and the laser source assembly 10 and the light modulation assembly 20 are arranged in an exit direction (referring to the direction M shown in FIG. 2) of the illumination beams of the laser projection apparatus 1. A second end of the light modulation assembly 20 is connected to the projection lens 30, and the light modulation assembly 20 and the projection lens 30 are arranged in an exit direction (referring to the direction N shown in FIG. 2) of the projection beams of the laser projection apparatus 1. The direction M is substantially perpendicular to the direction N. In one aspect, such connection structure may adapt to characteristics of a beam path of a reflective light valve in the light modulation assembly 20, and in another aspect, it is also conducive to shortening a length of a beam path in a one-dimensional direction, which is helpful for structural arrangement of the laser projection apparatus 1. For example, in a case where the laser source assembly 10, the light modulation assembly 20, and the projection lens 30 are disposed in a one-dimensional direction (e.g., the direction M), the length of the beam path in the one-dimensional direction is long, which is not conducive to the structural arrangement of the laser projection apparatus 1. The reflective light valve will be described below.

In some embodiments, the laser source assembly 10 may sequentially provide beams of three primary colors (beams of other colors may also be added on a basis of the beams of the three primary colors). Due to a phenomenon of visual perception of human eyes, what the human eyes see is white beams formed by mixing the beams of three primary colors. Alternatively, the laser source assembly 10 may also simultaneously output the beams of three primary colors, so as to continuously emit the white beams. The laser source assembly 10 may include a laser device that may emit a laser beam of at least one color, such as a red laser beam, a blue laser beam, or a green laser beam.

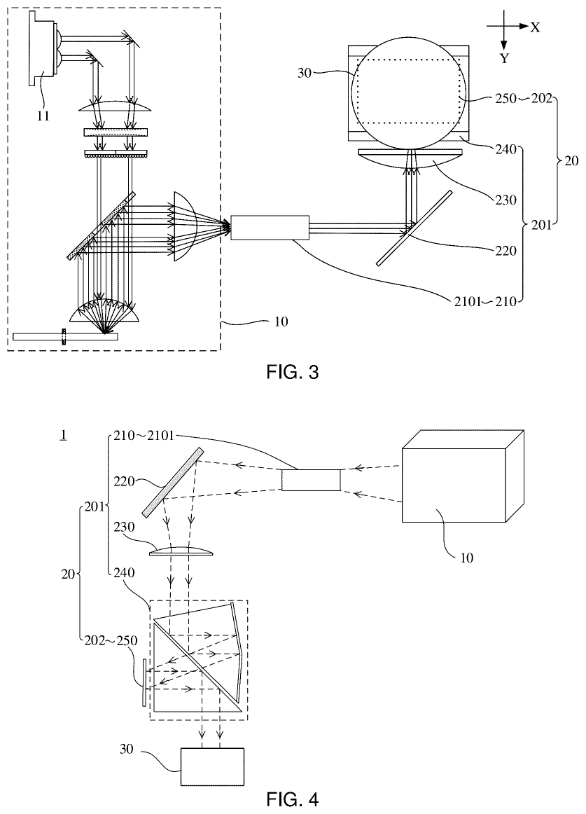

FIG. 3 is a diagram showing a beam path of a laser source assembly, a light modulation assembly, and a projection lens in a laser projection apparatus, in accordance with some embodiments. FIG. 4 is a diagram showing a principle of projection imaging by a laser projection apparatus, in accordance with some embodiments.

The illumination beams emitted by the laser source assembly 10 enter the light modulation assembly 20. Referring to FIGS. 3 and 4, the light modulation assembly 20 includes an illumination lens group 201 and a light modulation device (or the light valve) 202. The illumination lens group 201 is configured to receive the illumination beams provided by the laser source assembly 10 and propagate the illumination beams to the light modulation device 202 at a set angle and direction. The light modulation device 202 is configured to modulate the illumination beams to obtain the projection beams and reflect the projection beams into the projection lens 30.

In some embodiments, as shown in FIGS. 3 and 4, the illumination lens group 201 includes a homogenizing component 210, a lens component 230, and a prism group 240. The homogenizing component 210 is configured to receive the illumination beams provided by the laser source assembly 10 and homogenize the illumination beams. The lens component 230 is configured to converge the illumination beams exiting from the homogenizing component 210 onto the prism group 240. The prism group 240 is configured to reflect the illumination beams to the light modulation device 202.

In some embodiments, as shown in FIGS. 3 and 4, the homogenizing component 210 includes a light pipe 2101. A light outlet of the light pipe 2101 may be in a shape of a rectangle, so as to have a shaping effect on a beam spot. In this way, the shape of the beam spot of the illumination beams exiting from the light pipe 2101 may match a rectangular laser-receiving surface of the light modulation device 202. Alternatively, the homogenizing component 210 may include a fly-eye lens. The fly-eye lens may homogenize the incident illumination beams and shape the illumination beams, so as to output a rectangular beam spot.

In some embodiments, as shown in FIGS. 3 and 4, the illumination lens group 201 further includes a reflector 220. The reflector 220 is located on a laser-exit side of the homogenizing component 210 and configured to reflect the illumination beams exiting from the homogenizing component 210 to the lens component 230.

In some embodiments, as shown in FIGS. 3 and 4, the light modulation device 202 includes a digital micromirror device (DMD) 250. The DMD 250 is configured to use an image signal to modulate the illumination beams provided by the laser source assembly 10. That is to say, the digital micromirror device 250 controls the projection beams to display different luminance and gray scales according to different pixels in an image to be displayed, so as to finally produce an optical image. Depending on whether the light modulation device 202 transmits or reflects the illumination beams, the light modulation device 202 may be classified as a transmissive light modulation device or a reflective light modulation device. For example, the DMD 250 shown in FIG. 4 reflects the illumination beams, and thus it is the reflective light modulation device. A liquid crystal light valve transmits the illumination beams, and thus it is the transmissive light modulation device. In addition, the light modulation assembly 20 may be classified as a single-chip system, a double-chip system, or a three-chip system according to the number of the light modulation devices 202 used in the light modulation assembly 20. The light modulation device 202 in some embodiments of the present disclosure is the digital micromirror device 250.

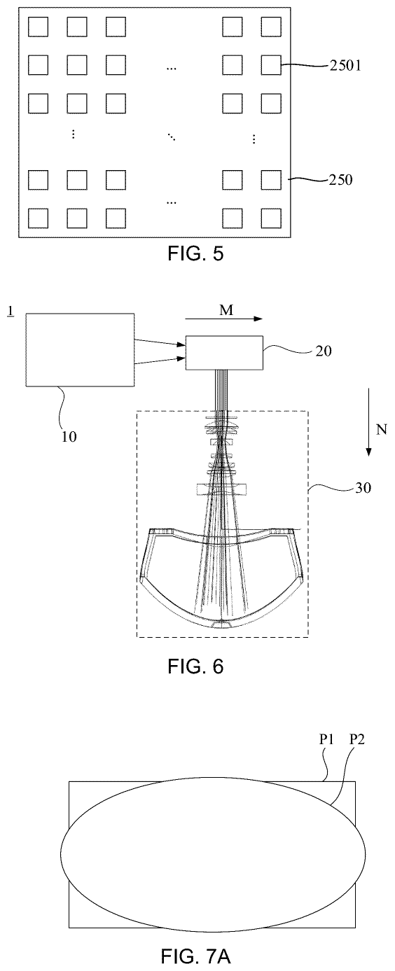

FIG. 5 is a diagram showing an arrangement of micromirrors in a digital micromirror device, in accordance with some embodiments.

As shown in FIG. 5, the digital micromirror device 250 includes thousands of micromirrors 2501 that may be individually driven to rotate. These micromirrors 2501 are arranged in an array. One micromirror 2501 (e.g., each micromirror 2501) corresponds to one pixel in the projection image to be displayed. The image signals may be converted into digital codes such as 0 or 1 after being processed. The micromirrors 2501 may swing in response to these digital codes. The gray scale of each pixel in a frame of an image is achieved according to durations of each micromirror 2501 in an ON state and an OFF state. In this way, the digital micromirror device 250 may modulate the illumination beams, thereby displaying the projection image. The ON state of the micromirror 2501 is a state that the micromirror 2501 is in and may be maintained when the illumination beams emitted by the laser source assembly 10 may enter the projection lens 30 after being reflected by the micromirror 2501. The OFF state of the micromirror 2501 is a state that the micromirror 2501 is in and may be maintained when the illumination beams emitted by the laser source assembly 10 do not enter the projection lens 30 after being reflected by the micromirror 2501.

FIG. 6 is a diagram showing another beam path of a laser source assembly, a light modulation assembly, and a projection lens in a laser projection apparatus, in accordance with some embodiments. In some embodiments, as shown in FIG. 6, the projection lens 30 includes a combination of a plurality of lenses, which are usually divided by groups, and are divided into a three-segment combination including a front group, a middle group, and a rear group, or a two-segment combination including a front group and a rear group. The front group is a lens group proximate to a laser-exit side (i.e., a side of the projection lens 30 away from the light modulation assembly 20 in the direction N in FIG. 6) of the laser projection apparatus 1, and the rear group is a lens group proximate to a laser-exit side (i.e., a side of the projection lens 30 proximate to the light modulation assembly 20 in the opposite direction of the direction N in FIG. 6) of the light modulation assembly 20. The projection lens 30 may include a zoom projection lens, or a prime focus-adjustable projection lens, or a prime projection lens.

In some embodiments, the laser projection apparatus 1 is an ultra-short-focus projection apparatus, and the projection lens 30 is an ultra-short-focus projection lens. A projection ratio of the projection lens 30 is usually less than 0.3, such as 0.24. In a case of a same projection distance, the less the projection ratio, the larger the projection image of the laser projection apparatus 1. The ultra-short-focus projection lens with a lesser projection ratio may adapt to a narrow space while ensuring the projection effect. In this way, the laser projection apparatus 1 may display a large-sized projection image with a lesser projection ratio. It will be noted that the projection ratio is a ratio of a distance between the laser projection apparatus 1 and the projection screen to a dimension (e.g., a width, a length, or a dimension of a diagonal) of the projection image.

For ease of description, some embodiments of the present disclosure are mainly described by considering an example in which the laser source assembly 10 sequentially outputs the beams of three primary colors, the light modulation device 202 of the light modulation assembly 20 is the digital micromirror device 250, and the projection lens 30 is the ultra-short-focus projection lens, however, this should not be construed as a limitation on the present disclosure.

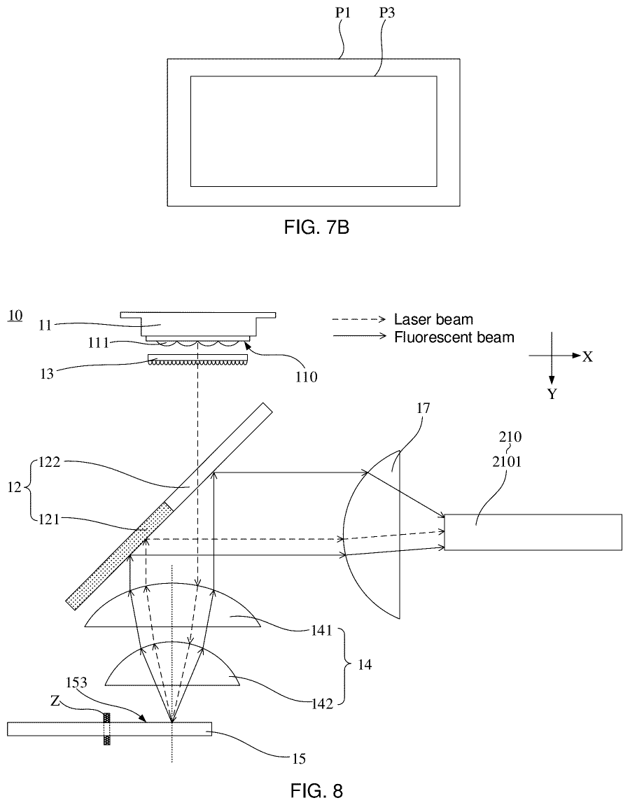

FIG. 7A is a schematic diagram of a beam spot at a light inlet of a light pipe in the related art. FIG. 7B is a schematic diagram of a beam spot at a light inlet of a light pipe, in accordance with some embodiments.

In the related art, since a laser beam has different divergence speeds in a fast axis direction and a slow axis direction, a beam spot formed by the laser beam is usually in a shape of an ellipse at a light inlet of the light pipe 2101 after the laser beam passes through multiple optical elements. In light of this, the light inlet of the light pipe 2101 is usually in a shape of a rectangle, so as to match shapes (e.g., rectangular shapes) of the digital micromirror device 250 and the projection image. Therefore, the shape of the beam spot formed by the laser beam does not match the shape of the light inlet of the light pipe 2101, so that the light pipe 2101 has a low utilization rate of the laser beam, which affects the display effect of the projection image.

Moreover, in a case where the optical system includes a convex lens and a concave lens, there is a spherical aberration between the convex lens and the concave lens, resulting in an uneven luminous intensity of the beam spot formed by the laser beam after passing through the convex lens and the concave lens. The luminous intensity of such beam spot has a Gaussian distribution. For example, the beam spot has a high luminous intensity at a center of the beam spot, while the beam spot has a low luminous intensity at an edge of the beam spot, which affects the display effect of the projection image. It will be noted that the spherical aberration is caused due to the difference in the converging effect of the central region and the edge region of the lens on light. Shapes matching with each other may be construed as substantially similar shapes.

In order to solve the above problems, a diffusion plate is usually provided to homogenize the laser beam. Although the diffusion plate homogenizes the laser beam, the beam spot formed by the laser beam after passing through the diffusion plate is still substantially in a shape of an ellipse after the laser beam passes through multiple optical elements. The diffusion plate cannot accurately adjust the shape of the beam spot, and the shape of the beam spot still does not match the shape of the light inlet of the light pipe 2101.

For example, as shown in FIG. 7A, a light inlet P1 of the light pipe 2101 is in a shape of a rectangle. The shape of the light inlet P1 does not match a shape of a third beam spot P2 formed at the light inlet P1 by the laser beam after passing through the diffusion plate. A portion of the third beam spot P2 proximate to the outer edge of the third beam spot P2 cannot enter the light pipe 2101, resulting in the loss of a part of the laser beam, and the light pipe 2101 has a low utilization rate of the laser beam. Moreover, since the beam spot formed by combining laser beams of different colors has a color boundary phenomenon, the phenomenon that the shape of the third beam spot P2 does not match the shape of the light inlet P1 may easily lead to an obvious color boundary phenomenon of the beam spot.

It will be noted that the combining laser beams may be construed as adjusting multiple laser beams to substantially a same beam path. In addition, the color boundary phenomenon of the beam spot refers to the beam spots of different colors having poor coincidence and the combined beam spot having obvious color boundaries after light (e.g., the laser beam or the fluorescent beam) of multiple colors are combined. For example, an outer ring of the beam spot formed by light of three colors: red, green, and blue; after being combined appears red. The color of the beam spot appears different colors: purple, blue, and yellow; in sequence along a direction from the outside to the inside. In this case, the beam spot formed by the light of three colors after being combined has uneven color distribution.

In light of this, in some embodiments of the present disclosure, a laser source assembly 10 is provided. The incident laser beam is homogenized, and the quality of the beam spot formed by the laser beam is improved by providing a microlens array 13 in the laser source assembly 10. Moreover, the microlens array 13 may also adjust the shape of the beam spot of the laser beam while homogenizing the incident laser beam, so as to improve the matching degree between the illumination beams (e.g., the laser beams and the fluorescent beam) provided by the laser source assembly 10 and the light inlet of the light pipe 2101 and improve the chromaticity uniformity of the beam spot formed by the illumination beams, thereby effectively improving the display effect of the projection image of the laser projection apparatus 1. The microlens array 13 will be described later.

The laser source assembly 10 in some embodiments of the present disclosure will be described in detail below.

FIG. 8 is a diagram showing a structure of a laser source assembly, in accordance with some embodiments.

In some embodiments, as shown in FIG. 8, the laser source assembly 10 includes a laser device 11, a microlens array 13, a combining component 12, a first lens group 14, and a phosphor wheel 15. The laser device 11, the microlens array 13, the combining component 12, the first lens group 14, and the phosphor wheel 15 are sequentially arranged in a second direction Y.

The laser device 11 is configured to emit laser beams. For example, the laser device 11 emits blue laser beams.

In some embodiments, a laser-exit direction (e.g., the second direction Y) of the laser device 11 is perpendicular to a laser-receiving surface 153 of the phosphor wheel 15. A plane where the laser-receiving surface 153 of the phosphor wheel 15 is located is parallel to a first direction X. It will be noted that, some embodiments of the present disclosure are described by considering an example in which the first direction X is perpendicular to the second direction Y. Of course, in some embodiments, an included angle between the first direction X and the second direction Y may also be an obtuse angle or an acute angle.

In some embodiments, the laser source assembly 10 may include a single laser device 11. The laser device 11 may emit one laser beam or a plurality of laser beams. For example, the laser device 11 is a multi-chip laser (MCL), and the MCL includes a plurality of laser chips arranged in an array. A laser beam emitted by the laser device 11 may refer to a laser beam emitted by one laser chip or a combination of laser beams emitted by the plurality of laser chips. The plurality of laser beams emitted by the laser device 11 may refer to a plurality of laser beams emitted by the plurality of laser chips.

For example, the laser device 11 includes fourteen laser chips, and the fourteen laser chips are arranged in a 7×2 array, so that the laser device 11 may emit fourteen laser beams. Here, the 7×2 array means that the fourteen laser chips are arranged in seven rows and two columns. Of course, the laser source assembly 10 may further include a plurality of laser devices 11, and the plurality of laser devices 11 may emit the plurality of laser beams.

In some embodiments, the plurality of laser chips in the laser device 11 may emit laser beams simultaneously. In a case where the plurality of laser chips emit laser beams simultaneously, the laser beams emitted by the laser device 11 have high luminance, and the laser beams also have high luminance after passing through optical elements in the laser source assembly 10, so that the phosphor wheel 15 may be excited to emit a fluorescent beam with high luminance. In this way, the projection image may have high luminance, which is conducive to improving the display effect of the laser projection apparatus 1.

Of course, the plurality of laser chips of the laser device 11 may also emit laser beams at different times. For example, the plurality of laser chips include a first laser chip and a second laser chip. The first laser chip and the second laser chip may emit laser beams alternately. Since only some laser chips in the laser device 11 emit laser beams at a same time, the beam of the emitted laser beams is thin, and the beam of the laser beams is also thin after the laser beams pass through the optical elements in the laser source assembly 10.

In this way, all laser beams may exit from a light outlet of the laser source assembly 10 after passing through the optical elements, thereby avoiding wasted light and improving the utilization rate of light. In addition, since there is no need for the laser chips in the laser device 11 to continuously emit laser beams, pulse current may be used to power the laser chips. The energy of the pulse current is high, so that the laser chips may emit laser beams with high luminance. Moreover, there is no need for the laser chips to continuously emit laser beams, which is conducive to improving the service life of the laser chips in the laser device 11.

Since a speed at which the laser beam emitted by the laser chip of the laser device 11 diverges in the fast axis direction is greater than that in the slow axis direction, the laser beam has different divergence angles in the fast axis direction and the slow axis direction, so that the beam spot of the laser beam is in a shape of an ellipse. In addition, in order to make the laser beam incident onto the subsequent beam path as an approximately parallel beam, as shown in FIG. 8, the laser device 11 further includes a collimating lens group 111 disposed on a laser-exit surface 110 of the laser device 11 and configured to collimate the laser beams emitted by the laser chips. In this way, the laser beams collimated by the collimating lens group 111 may exit from the laser device 11 as the approximately parallel beam, and a size of the beam spot formed by the laser beams is small, which is conducive to improving the utilization rate of the laser beam.

However, the laser beams collimated by the collimating lens group 111 have different divergence characteristics in the fast axis direction and the slow axis direction. For example, divergence angles of the laser beams collimated by the collimating lens group 111 in the slow axis direction is greater than that in the fast axis direction. In this way, dimensions of the beam spots formed by the laser beams on the microlens array 13 in the slow axis direction is greater than dimensions of the beam spots in the fast axis direction, so that the beam spots formed by the laser beams on the microlens array 13 are in a shape of an ellipse.

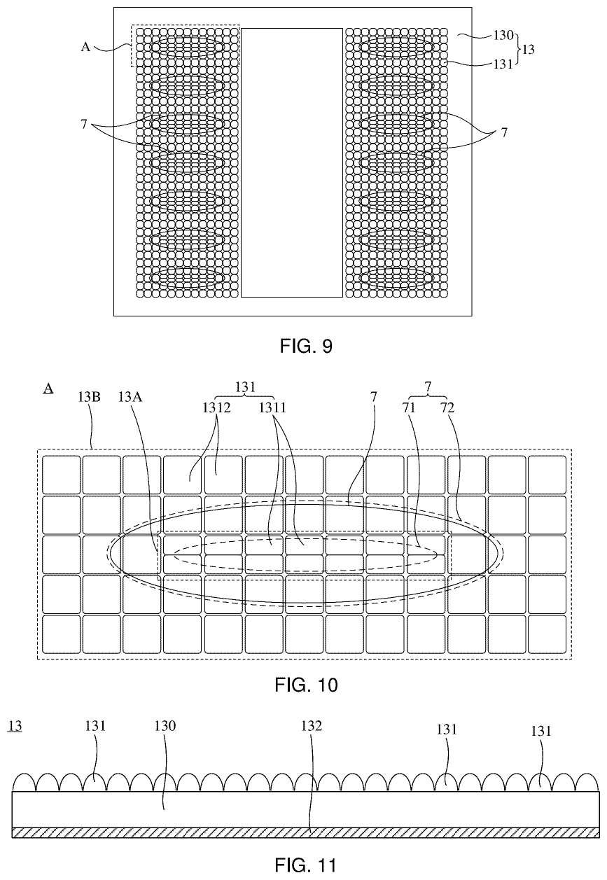

FIG. 9 is a diagram showing a structure of a microlens array, in accordance with some embodiments. FIG. 10 is a partial enlarged view of the box A in FIG. 9. For example, as shown in FIG. 9, in a case where the laser device 11 emits a plurality of laser beams, the plurality of laser beams irradiate on the microlens array 13 and form a plurality of first beam spots 7, and the plurality of first beam spots 7 are each in a shape of an ellipse. As shown in FIG. 10, the first beam spot 7 includes a first region 71 and a second region 72, and the second region 72 surrounds the first region 71. The first region 71 is a middle region of the first beam spot 7, and the second region 72 is a peripheral region of the first beam spot 7. A luminous intensity of the first beam spot 7 has a Gaussian distribution. The luminous intensity of the first region 71 of the first beam spot 7 is higher than the luminous intensity of the second region 72 of the first beam spot 7.

In this case, as shown in FIG. 8, the microlens array 13 is located on a laser-exit side of the laser device 11 and configured to increase the divergence angles of the incident laser beam in the slow axis direction and the fast axis direction, so as to homogenize the incident laser beam and adjust the shape of the beam spot of the laser beam. The luminous intensity of the beam spot of the laser beam is uniformly distributed and the shape of the beam spot matches (i.e., is similar to) the shape of the light inlet of the light pipe 2101 after the laser beam passes through the microlens array 13.

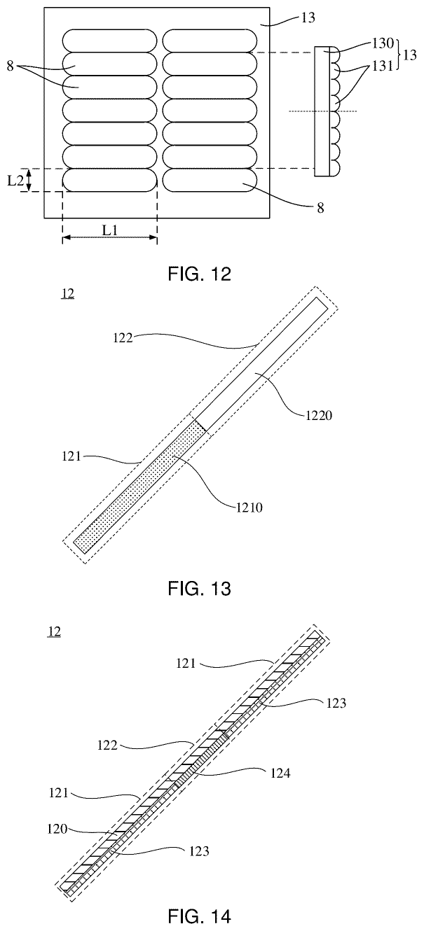

FIG. 11 is a diagram showing a structure of another microlens array, in accordance with some embodiments. FIG. 12 is a schematic diagram of beam spots formed by laser beams passing through a microlens array, in accordance with some embodiments. For example, as shown in FIGS. 11 and 12, the microlens array 13 includes a first substrate 130 and a plurality of microlenses 131. A plane where the first substrate 130 is located is perpendicular to a laser-exit direction (e.g., the second direction Y) of the laser device 11. The plurality of microlenses 131 are arranged in an array and disposed on a surface of the first substrate 130 away from or proximate to the laser device 11. In this case, the microlens array 13 is a single-sided microlens array. For example, as shown in FIG. 8, a laser-incident surface of the microlens array 13 is a plane and a laser-exit surface of the microlens array 13 is a curved surface. Of course, the laser-incident surface of the microlens array 13 may also be a curved surface, and the laser-exit surface of the microlens array 13 may be a plane.

When a laser beam passes through the microlens array 13, the plurality of microlenses 131 may split the laser beam into multiple laser beams and diverge the multiple laser beams at a divergence angle, thereby homogenizing the laser beam incident onto the microlens array 13. It will be noted that the single-sided microlens array only homogenizes the incident laser beam, and the homogenized laser beam needs to be converged onto the laser-receiving surface 153 of the phosphor wheel 15 by the first lens group 14, so as to form a small beam spot with uniform luminous intensity on the phosphor wheel 15. In addition, the plurality of first beam spots 7 after being converged by the first lens group 14 may irradiate on substantially a same region of the phosphor wheel 15.

In some embodiments, a radius of a curved surface of the microlens in the single-sided microlens array is equal to a first preset value.

In some embodiments of the present disclosure, the excitation effect of the laser beam on the fluorescent material in the phosphor wheel 15 and the quality of the illumination beams emitted by the laser source assembly 10 may be improved by arranging the single-sided microlens array. Moreover, the single-sided microlens array may receive and homogenize the incident light with a large angle, thereby increasing a laser-exit angle of the laser device 11, reducing light loss, and improving the utilization rate of light.

Of course, the microlens array 13 in some embodiments of the present disclosure may also be a double-sided microlens array. That is to say, the microlenses 131 are disposed on the surfaces of the first substrate 130 away from and proximate to the laser device 11. Here, sizes (e.g., radii of curvature) of the microlenses 131 on both surfaces may be equal to each other, and the laser beams homogenized by the double-sided microlens array may be imaged on the phosphor wheel 15.

In some embodiments, a radius of a curved surface of the microlens in the double-sided microlens array is equal to a second preset value. A ratio of the second preset value to the first preset value is greater than or equal to 1.8 and less than or equal to 2.3. For example, the ratio of the second preset value to the first preset value is equal to 2.

The following is described by considering an example in which the microlens array 13 uses the single-sided microlens array.

The laser beam incident on the microlens 131 diverges at different angles along two different directions of the microlens 131 on a two-dimensional plane, so that the laser beam may have different divergence angles in different dimensional directions after being diverged by the microlens 131. Here, the different dimensional directions may refer to the fast axis direction and the slow axis direction of the laser beam or may refer to two different directions of the microlens 131 on the two-dimensional plane. It will be noted that the two-dimensional plane may refer to a plane parallel to the first substrate 130 or a plane perpendicular to the laser-exit direction of the laser device 11.

In some embodiments, in an example where the light inlet of the light pipe 2101 is in a shape of a rectangle, the microlens array 13 is configured to increase the divergence angles of the plurality of laser beams emitted by the laser device 11 in the slow axis and fast axis directions, so that a ratio of the divergence angle of the laser beam diverged by the microlens array 13 in the slow axis direction to the divergence angle of the laser beam in the fast axis direction is proportional to a length-width ratio of the light inlet of the light pipe 2101. An angle at which the microlens array 13 diffuses the incident laser beams in the fast axis direction is different from an angle at which the microlens array 13 diffuses the incident laser beams in the slow axis direction.

In some examples, an orthogonal projection of the microlens 131 on the first substrate 130 is in a shape of a rectangle. A divergence angle of the laser beam in a long side direction of the microlens 131 is greater than a divergence angle of the laser beam in a short side direction of the microlens 131 after the laser beam is diverged by the microlens 131. For example, a ratio of an angle at which the microlens 131 diffuses the laser beam in the long side direction of the microlens 131 to an angle at which the microlens 131 diffuses the laser beam in the short side direction of the microlens 131 is greater than or equal to a first preset threshold, and the first preset threshold is equal to 1.7.

For example, as shown in FIG. 12, a first maximum distance L1 of a second beam spot 8 formed by the laser beam diverged by the microlens array 13 in the long side direction of the microlens 131 is greater than a second maximum distance L2 of the second beam spot 8 in the short side direction of the microlens 131. Here, the long side direction of the microlens 131 is a direction in which the divergence angle of the laser beam corresponding to the second beam spot 8 is large, and the short side direction of the microlens 131 is a direction in which the divergence angle of the laser beam corresponding to the second beam spot 8 is small.

A ratio of the first maximum distance L1 to the second maximum distance L2 is greater than or equal to 1.7. For example, the ratio of the first maximum distance L1 to the second maximum distance L2 is equal to 1.8. In addition, the ratio of the first maximum distance L1 to the second maximum distance L2 is less than or equal to a second preset threshold (e.g., the second preset threshold being equal to 3), so as to match a length-width ratio of the projection image and avoid the shape of the projection image being excessively elongated. In addition, the long side direction and the short side direction of the microlens 131 in FIG. 12 may be the same as or different from the slow-axis and fast-axis directions of the laser beam, respectively.

For example, in a case where the slow axis direction of the laser beam is the same as the long side direction of the microlens 131, and the fast axis direction of the laser beam is the same as the short side direction of the microlens 131, an angle at which the microlens 131 diffuses the laser beam in the slow axis direction is greater than that in the fast axis direction. For example, in the case where the slow axis direction of the laser beam is the same as the long side direction of the microlens 131, and the fast axis direction of the laser beam is the same as the short side direction of the microlens 131, the angle at which the microlens 131 diffuses the laser beam in the slow axis direction is greater than or equal to 0.5°, and the angle at which the microlens 131 diffuses the laser beam in the fast axis direction is greater than or equal to 0.3°. In this way, the first beam spot 7 in a shape of an ellipse may be changed into the second beam spot 8 in a shape of an approximate rectangle after passing through the microlens array 13, so as to match the shape of the light inlet of the light pipe 2101.

Of course, the slow axis direction of the laser beam may also be the same as the short side direction of the microlens 131, and the long side direction of the microlens 131 may also be the same as the fast axis direction of the laser beam. In this case, the angle at which the microlens 131 diffuses the laser beam in the slow axis direction is greater than or equal to 0.5°.

In some embodiments of the present disclosure, during the propagation process of the laser beam, the laser beam is in a non-focused state (i.e., the laser beam diverging), and the laser beam has a divergence angle and a size (e.g., the size of the beam spot formed by the laser beam). The microlens array 13 may change the divergence angle of the laser beam, so that the laser beam may have different divergence angles in different directions, and a ratio of the divergence angles in different directions may be proportional to the length-width ratio of the light inlet of the light pipe 2101.

In this way, when the laser beam propagates to the light inlet of the light pipe 2101 after passing through the microlens array 13, the shape of the beam spot of the laser beam at the light inlet may match the shape of the light inlet of the light pipe 2101. For example, in a case where the beam spot of the laser beam at the light inlet and the light inlet of the light pipe 2101 are each in a shape of a rectangle, the length-width ratio of the beam spot is proportional to a ratio of an angle at which the microlens 131 diffuses the laser beam in the long side direction to an angle at which the microlens 131 diffuses the laser beam in the short side direction. As shown in FIG. 7B, in a case where the ratio of the angle at which the microlens 131 diffuses the laser beam in the long side direction to the angle at which the microlens 131 diffuses the laser beam in the short side direction is equal to the length-width ratio of the light inlet of the light pipe 2101, a length-width ratio of a fourth beam spot P3 is equal to the length-width ratio of the light inlet P1 of the light pipe 2101. In this way, the illumination beams exiting from the laser source assembly 10 may be imaged at the light inlet of the light pipe 2101, light loss may be reduced, the utilization rate of the incident laser beam by the light pipe 2101 may be improved, and the chromaticity unevenness problem caused by the color boundary phenomenon of the beam spot at the light inlet P1 may be avoided.

In some embodiments, as shown in FIG. 10, the plurality of microlenses 131 include a plurality of first microlenses 1311 and a plurality of second microlenses 1312. The plurality of first microlenses 1311 correspond to the first region 71, and the plurality of second microlenses 1312 correspond to the second region 72. Moreover, an ability of the first microlens 1311 for homogenizing light is higher than an ability of the second microlens 1312 for homogenizing light.

For example, as shown in FIG. 10, the corresponding number of first microlenses 1311 is provided according to a size of the first region 71, so that a first homogenizing light region 13A formed by the plurality of first microlenses 1311 may overlap with the first region 71. The corresponding number of second microlenses 1312 is provided according to a size of the second region 72, so that a second homogenizing light region 13B formed by the plurality of second microlenses 1312 may overlap with the second region 72. Moreover, an ability of the first homogenizing light region 13A for homogenizing light is higher than an ability of the second homogenizing light region 13B for homogenizing light.

Here, the ability for homogenizing light may be construed as a characteristic of adjusting a beam spot with uneven luminous intensity into a beam spot with uniform luminous intensity.

In some embodiments, a size of the first microlens 1311 is less than a size of the second microlens 1312. In this way, in a case where the first homogenizing light region 13A and the second homogenizing light region 13B have a same size, the number of microlenses 131 in the first homogenizing light region 13A is greater than the number of microlenses 131 in the second homogenizing light region 13B, so that the number of laser beams split by the first homogenizing light region 13A is greater than the number of laser beams split by the second homogenizing light region 13B, and the ability of the first homogenizing light region 13A to homogenize light may be greater than the ability of the second homogenizing light region 13B to homogenize light.

It will be noted that the size of the microlens 131 may refer to an area of a laser-receiving surface (i.e., a portion of the microlens 131 irradiated by the laser beam) of the microlens 131. For example, in a case where the laser-receiving surface of the microlens 131 is in a shape of a rectangle, the size of the microlens 131 refers to a product of the length and the width of the laser-receiving surface. The size of a homogenizing light region (i.e., the first homogenizing light region 13A and the second homogenizing light region 13B) may refer to areas of orthogonal projections of the laser-receiving surfaces of the plurality of microlenses 131 in the homogenizing light region on the first substrate 130.

In some embodiments, the size of at least one of the first microlens 1311 or the second microlens 1312 increases in a direction (i.e., from inside to outside) from the center of the first beam spot 7 to the edge of the first beam spot 7. For example, the size of the first microlens 1311 located at the center of the first region 71 is less than the size of the first microlens 1311 located at the edge of the first region 71. In this way, the size of the microlens 131 increases in the direction from the center of the first beam spot 7 to the edge of the first beam spot 7, which may match the first beam spot 7 whose luminous intensity has a Gaussian distribution, thereby further improving the homogenizing light effect of the microlens array 13 on the first beam spot 7.

In some embodiments, an angle at which the first microlens 1311 diffuses the laser beam is greater than an angle at which the second microlens 1312 diffuses the laser beam. For example, the angle at which the microlens 131 diffuses the incident laser beam is related to a focal length of the microlens 131 or a length-width ratio of the rectangular laser-receiving surface of the microlens 131. The angle at which the microlens 131 diffuses the laser beam may be controlled by adjusting the focal length of the microlens 131 or the length-width ratio of the rectangular laser-receiving surface of the microlens 131.

In some embodiments, as shown in FIG. 11, the microlens array 13 further includes a diffusion layer 132 (e.g., a diffusion film or a diffusion plate), and the diffusion layer 132 is configured to diverge the incident laser beam. The diffusion layer 132 is located on the surface of the first substrate 130 away from the laser device 11 or proximate to the laser device 11 and at least overlaps with the first region 71 of the first beam spot 7. For example, the diffusion layer 132 covers the surface of the first substrate 130 away from the laser device 11 or proximate to the laser device 11, or the diffusion layer 132 covers a surface of the first substrate 130 located within the first region 71 of the first beam spot 7. That is to say, on the plane where the first substrate 130 is located, an orthogonal projection of the diffusion layer 132 overlaps with the orthogonal projections of the plurality of first microlenses 1311. In this way, the diffusion layer 132 may homogenize the central region of the first beam spot 7 and improve the uniformity of the luminous intensity distribution of the beam spot passing through the microlens array 13.

In some embodiments of the present disclosure, different regions of the first beam spot 7 may be homogenized in a targeted manner by arranging the plurality of first microlenses 1311 and the plurality of second microlenses 1312 to correspond to different regions of the first beam spot 7. Moreover, the ability of the first microlens 1311 to homogenize light may be higher than the ability of the second microlens 1312 to homogenize light by adjusting the structure of the microlens array 13, so as to match the luminous intensity distribution characteristic of the first beam spot 7, reduce the difference in luminous intensity distribution of different regions of the first beam spot 7, and improve the homogenizing light effect of the microlens array 13.

In addition, the utilization rate of the outer edge of the first beam spot 7 by the microlens array 13 may be improved by providing the second microlenses 1312 with a large size, so that the laser beam corresponding to the outer edge of the first beam spot 7 may be completely incident on the microlenses 131, and then incident on the phosphor wheel 15 after being diverged by the microlenses 131, thereby further improving the utilization rate of the laser beam.

The combining component 12 in some embodiments of the present disclosure is described in detail below.

As shown in FIG. 8, the combining component 12 is located on a side of the microlens array 13 away from the laser device 11 and disposed obliquely with respect to the laser-exit direction (e.g., the second direction Y or an arrangement direction of the laser device 11 and the combining component 12) of the laser device 11. The combining component 12 includes a reflecting region 121 and a transmitting region 122 that are alternately arranged. The reflecting region 121 is configured to reflect the incident laser beam and the incident fluorescent beam. The transmitting region 122 is configured to transmit the incident laser beam.

FIG. 13 is a diagram showing a structure of a combining component, in accordance with some embodiments. FIG. 14 is a diagram showing a structure of another combining component, in accordance with some embodiments.

In some embodiments, the combining component 12 is separate piece members. For example, as shown in FIG. 13, the combining component 12 includes a reflecting portion 1210 and a transmitting portion 1220. The reflecting portion 1210 is located in the reflecting region 121, and the transmitting portion 1220 is located in the transmitting region 122. The reflecting portion 1210 is configured to reflect the incident laser beam and the incident fluorescent beam. The transmitting portion 1220 is configured to transmit the laser beam from the laser device 11 and reflect the laser beam and the fluorescent beam that are different in color from the laser beam.

For example, in a case where the laser device 11 emits blue laser beams, the transmitting portion 1220 is a dichroic mirror transmitting the blue laser beams and reflecting laser beams and fluorescent beams of other colors. The reflecting portion 1210 may be a reflecting mirror, or a lens with a full-wavelength reflecting film on its surface, so as to reflect laser beams and fluorescent beams in all wavelengths, thereby improving the utilization rate of light (e.g., the laser beams and the fluorescent beam). The reflecting mirror and the dichroic mirror are connected with each other, so as to form the combining component 12. It will be noted that the transmitting portion 1220 may also be a through hole or a transparent lens, so as to transmit the laser beams from the laser device 11.

Of course, in some embodiments, the combining component 12 may be a one-piece member. For example, as shown in FIG. 14, the combining component 12 includes a third substrate 120, a first coating film 123, and a second coating film 124. The third substrate 120 may be a transparent substrate. The first coating film 123 and the second coating film 124 are disposed on the third substrate 120. The first coating film 123 is located in the reflecting region 121, so as to reflect the incident laser beam and the incident fluorescent beam. The first coating film 123 may be a full-wavelength reflecting film. Alternatively, the first coating film 123 may be a reflecting film for at least one of the wavelength range of red light, the wavelength range of green light, and the wavelength range of blue light. The second coating film 124 is located in the transmitting region 122, and the second coating film 124 is configured to transmit the laser beams from the laser device 11 and reflect laser beams and fluorescent beams that are different in color from the laser beams. For example, the second coating film 124 is a dichroic film.

Of course, the reflecting region 121 may also be made of reflective materials, and the transmitting region 122 may also be made of dichroic materials. In this case, there is no need to provide a reflecting film and a dichroic film.

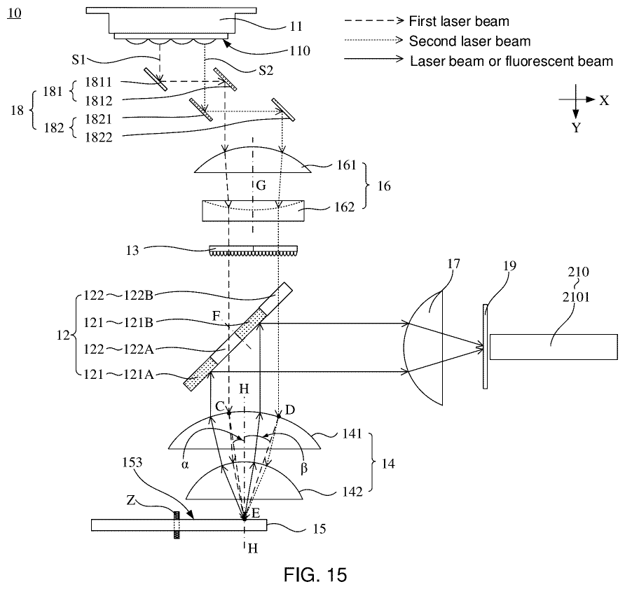

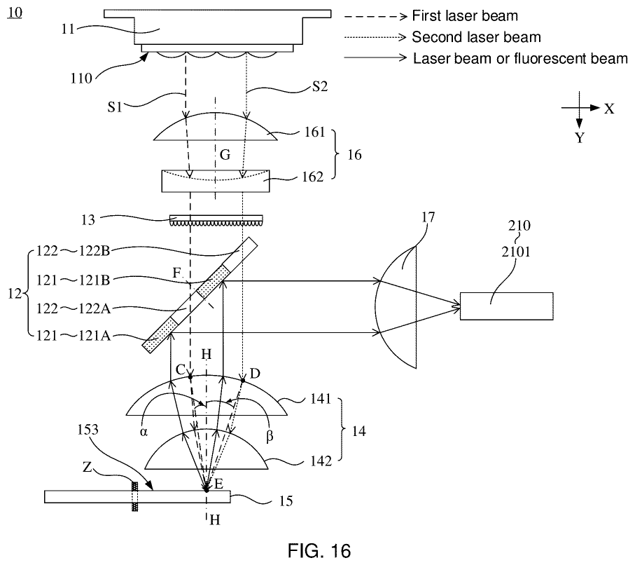

FIG. 15 is a diagram showing a structure of another laser source assembly, in accordance with some embodiments. FIG. 16 is a diagram showing a structure of yet another laser source assembly, in accordance with some embodiments. Compared with FIG. 8, the combining component 12 in FIGS. 15 and 16 includes a plurality of reflecting regions 121 and a plurality of transmitting regions 122.

In some embodiments, as shown in FIG. 8, the combining component 12 includes one reflecting region 121 and one transmitting region 122. The reflecting region 121 is proximate to the phosphor wheel 15, and the transmitting region 122 is proximate to the laser device 11. For example, the reflecting region 121 is closer to the phosphor wheel 15 than the transmitting region 122.

Of course, in some embodiments, the combining component 12 may further include a plurality of reflecting regions 121 and a plurality of transmitting regions 122, and the plurality of transmitting regions 122 are arranged at intervals.

For example, as shown in FIGS. 15 and 16, the combining component 12 includes a first reflecting region 121A, a second reflecting region 121B, a first transmitting region 122A, and a second transmitting region 122B. The first reflecting region 121A, the first transmitting region 122A, the second reflecting region 121B, and the second transmitting region 122B are alternately arranged in sequence. The first reflecting region 121A is proximate to the phosphor wheel 15, and the second transmitting region 122B is proximate to the laser device 11. The laser device 11 emits a first laser beam S1 and a second laser beam S2, and the first laser beam S1 and the second laser beam S2 are incident on the first transmitting region 122A and the second transmitting region 122B, respectively. It will be noted that since the plurality of transmitting regions 122 are arranged at intervals, the plurality of laser beams incident on the plurality of transmitting regions 122 may also be arranged at intervals.

In this case, the plurality of microlenses 131 in the microlens array 13 are divided into different regions, and the different regions are arranged at intervals, so as to correspond to the plurality of laser beams arranged at intervals. For example, as shown in FIG. 9, in a case where the laser device 11 emits the first laser beam S1 and the second laser beam S2, the microlens array 13 is divided into two portions arranged at an interval.

In addition, in a case where the combining component 12 includes one reflecting portion 1210, the plurality of reflecting regions 121 may be different portions of the reflecting portion 1210. In a case where the combining component 12 includes a plurality of reflecting portions 1210, the plurality of reflecting regions 121 may correspond to the plurality of reflecting portions 1210, respectively.

In some embodiments, as shown in FIGS. 15 and 16, the beam spots formed on the first lens group 14 by any two laser beams of the plurality of laser beams incident on the plurality of transmitting regions 122 are asymmetrical with respect to an optical axis H of the first lens group 14. Moreover, the plurality of laser beams do not pass through the optical axis H of the first lens group 14.

In some examples, the first laser beam S1 and the second laser beam S2 are incident on the first transmitting region 122A and the second transmitting region 122B, respectively. The first laser beam S1 and the second laser beam S2 pass through the first transmitting region 122A and the second transmitting region 122B, respectively, and are then incident on the first lens group 14. The beam spot formed on the first lens group 14 by the first laser beam S1 and the beam spot formed on the first lens group 14 by the second laser beam S2 are asymmetrical with respect to the optical axis H of the first lens group 14. That is to say, a position of the first lens group 14 irradiated by the first laser beam S1 and a position of the first lens group 14 irradiated by the second laser beam S2 are asymmetrical with respect to the optical axis H of the first lens group 14.

For example, as shown in FIGS. 15 and 16, the first laser beam S1 is closer to the optical axis H of the first lens group 14 than the second laser beam S2. Of course, in some embodiments, any position in the beam spot formed on the first lens group 14 by the first laser beam S1 and any position in the beam spot formed on the first lens group 14 by the second laser beam S2 are also asymmetrical with respect to the optical axis H.

According to the reflection law, in a case where the first laser beam S1 and the second laser beam S2 are asymmetrical with respect to the optical axis H of the first lens group 14, the beam path of the first laser beam S1 reflected by the phosphor wheel 15 is separated from (i.e., does not overlap with) the incident beam path of the second laser beam S2 in the first lens group 14, and the beam path of the second laser beam S2 reflected by the phosphor wheel 15 is also separated from the incident beam path of the first laser beam S1 in the first lens group 14. In this way, light loss caused by most of the laser beams reflected by the phosphor wheel 15 incident on the transmitting region 122 may be avoided.

Moreover, in a case where a laser beam is incident on the first lens group 14 along the optical axis H, there will be no change in the optical characteristics of the laser beam. Therefore, if the laser beam transmitted by the transmitting region 122 passes through the first lens group 14 along the optical axis H of the first lens group 14 and is incident on the phosphor wheel 15, the laser beams reflected by the phosphor wheel 15 will also pass through the first lens group 14 along the optical axis H of the first lens group 14 and then be incident on the transmitting region 122, so that the laser beams cannot reach the reflecting region 121 of the combining component 12 and cannot be reflected to the light outlet of the laser source assembly 10 by the reflecting region 121. Therefore, in some embodiments, the laser beams emitted by the laser device 11 need to be incident on a region other than the optical axis H in the first lens group 14.

It will be noted that the first laser beam S1 and the second laser beam S2 may be two independent laser beams, or two portions of one laser beam, or any two laser beams of the plurality of laser beams emitted by the laser device 11.

In some embodiments, an area of the transmitting region 122 may be less than an area of the reflecting region 121. For example, in the combining component 12, a total area of all transmitting regions 122 is less than a total area of all reflecting regions 121. Alternatively, the area of each transmitting region 122 is less than the area of each adjacent reflecting region 121. Alternatively, the area of each transmitting region 122 is less than the area of each reflecting region 121. It will be noted that, the area of the transmitting region 122 of the combining component 12 needs to be sufficient to allow the incident laser beam to pass through.

In some embodiments, the area of the transmitting region 122 may be less than a quarter of the area of the adjacent reflecting region 121.

In some embodiments, as shown in FIGS. 15 and 16, the first reflecting region 121A and the second transmitting region 122B have a same shape and size and are symmetrical with respect to a central axis F of the combining component 12. The second reflecting region 121B and the first transmitting region 122A have a same shape and size and are symmetrical with respect to the central axis F of the combining component 12. At least a portion of an orthogonal projection of the first reflecting region 121A on the laser-receiving surface 153 of the phosphor wheel 15 and at least a portion of an orthogonal projection of the second transmitting region 122B on the laser-receiving surface 153 of the phosphor wheel 15 are symmetric with respect to the optical axis H. At least a portion of an orthogonal projection of the second reflecting region 121B on the laser-receiving surface 153 of the phosphor wheel 15 and at least a portion of an orthogonal projection of the first transmitting region 122A on the laser-receiving surface 153 of the phosphor wheel 15 are symmetric with respect to the optical axis H.

In this way, the first laser beam S1 emitted by the laser device 11 is transmitted to the first lens group 14 by the first transmitting region 122A and converged to the phosphor wheel 15 by the first lens group 14. Then, most of the first laser beam S1 may be incident on the second reflecting region 121B after the first laser beam S1 is reflected by the phosphor wheel 15. The second laser beam S2 emitted by the laser device 11 is transmitted to the first lens group 14 by the second transmitting region 122B and converged to the phosphor wheel 15 by the first lens group 14. Then, most of the second laser beam S2 may be incident on the first reflecting region 121A after the second laser beam S2 is reflected by the phosphor wheel 15.

In this way, the loss of the laser beams after passing through the transmitting region 122 and the reflecting region 121 may be reduced, and the utilization rate of the laser beams may be improved. Moreover, there is no need to provide a relay loop system in the laser source assembly 10 provided by some embodiments of the present disclosure. The laser beams and the fluorescent beam may be combined by only one combining component 12. The laser source assembly 10 has a compact structure, which is conducive to miniaturization of the laser source assembly 10.

It will be noted that if the phosphor wheel 15 includes a laser transmitting region, an additional relay loop system composed of at least three mirrors is required be provided, so as to reflect the laser beam passing through the laser transmitting region of the phosphor wheel 15 to the light outlet of the laser source assembly 10. The use of the relay loop system causes an increase in the optical elements of the laser source assembly 10, which is not conducive to the miniaturization of the laser projection apparatus 1.

In some embodiments, as shown in FIG. 15, the laser source assembly 10 further includes a mirror group 18, so that the laser beams emitted by the laser device 11 may be incident on the plurality of transmitting regions 122 arranged at intervals. The mirror group 18 is located between the laser device 11 and the microlens array 13 and configured to split the laser beams emitted by the laser device 11 into a plurality of laser beams and propagate the multiple laser beams to the plurality of transmitting regions 122, respectively. The number of laser beams split by the mirror group 18 is the same as the number of transmitting regions 122.

In some examples, as shown in FIG. 15, the laser beams emitted by the laser device 11 are split into two laser beams by the mirror group 18, and the two laser beams are reflected to the first transmitting region 122A and the second transmitting region 122B, respectively.

For example, as shown in FIG. 15, the mirror group 18 includes a first mirror sub-group 181 and a second mirror sub-group 182. The first mirror sub-group 181 includes a first mirror 1811 and a second mirror 1812 that are arranged parallel to each other. The first mirror 1811 reflects a first portion of the laser beams emitted by the laser device 11 to the second mirror 1812, and the second mirror 1812 reflects the incident laser beam to the first transmitting region 122A. The second mirror sub-group 182 includes a third mirror 1821 and a fourth mirror 1822 that are arranged parallel to each other. The third mirror 1821 reflects a second portion of the laser beams emitted by the laser device 11 to the fourth mirror 1822, and the fourth mirror 1822 reflects the incident laser beam to the second transmitting region 122B.

In this way, the mirror group 18 may split the laser beams emitted by the laser device 11 into two laser beams and reflect the two laser beams to the first transmitting region 122A and the second transmitting region 122B, respectively.

It will be noted that an angle between the plurality of mirrors and the second direction Y may be at a preset angle, so that the laser beam that has been reflected twice may propagate along the second direction Y. In addition, a distance between the multiple laser beams obtained by splitting may be adjusted to match a distance between the plurality of transmitting regions 122 by adjusting the positions of the mirrors, so that the laser beams emitted by the laser device 11 may be incident on the plurality of transmitting regions 122, thereby reducing light loss and improving the utilization rate of the laser beams. Moreover, it may also prevent the laser beam from being incident on the optical axis H of the first lens group 14, which is helpful for the first lens group 14 to converge the laser beams.

Of course, the laser source assembly 10 in some embodiments of the present disclosure is not limited thereto. In some embodiments, the laser source assembly 10 may further include a plurality of laser devices 11 corresponding to the plurality of transmitting regions 122, so that multiple laser beams emitted by the plurality of laser devices 11 may be incident on the plurality of transmitting regions 122, respectively. Alternatively, as shown in FIG. 16, the laser source assembly 10 includes one laser device 11, and the laser device 11 emits a plurality of laser beams to correspond to the plurality of transmitting regions 122.

Some embodiments of the present disclosure are described by considering an example in which the number of laser beams from the laser device 11 and incident on the combining component 12 is equal to the number of the transmitting regions 122, and the number of the transmitting regions 122 and the number of the reflecting regions 121 are equal to each other. Of course, the number of at least one of the transmitting regions 122 or the reflecting regions 121 may also be greater than the number of laser beams emitted by the laser device 11, so that an orthogonal projection of the combining component 12 on the phosphor wheel 15 may overlap with an orthogonal projection of the first lens group 14 on the phosphor wheel 15.

For example, in a case where the laser device 11 emits two laser beams, one reflecting region may further be disposed on a side of the second transmitting region 122B proximate to the laser device 11 based on the combining component 12 shown in FIG. 15, in this case, the combining component 12 includes three reflecting regions, so that the laser beams and the fluorescent beam exiting from the first lens group 14 may be reflected to the light outlet of the laser source assembly 10 to the maximum extent by the reflecting region 121, thereby improving the utilization rate of the laser beams and the fluorescent beam.

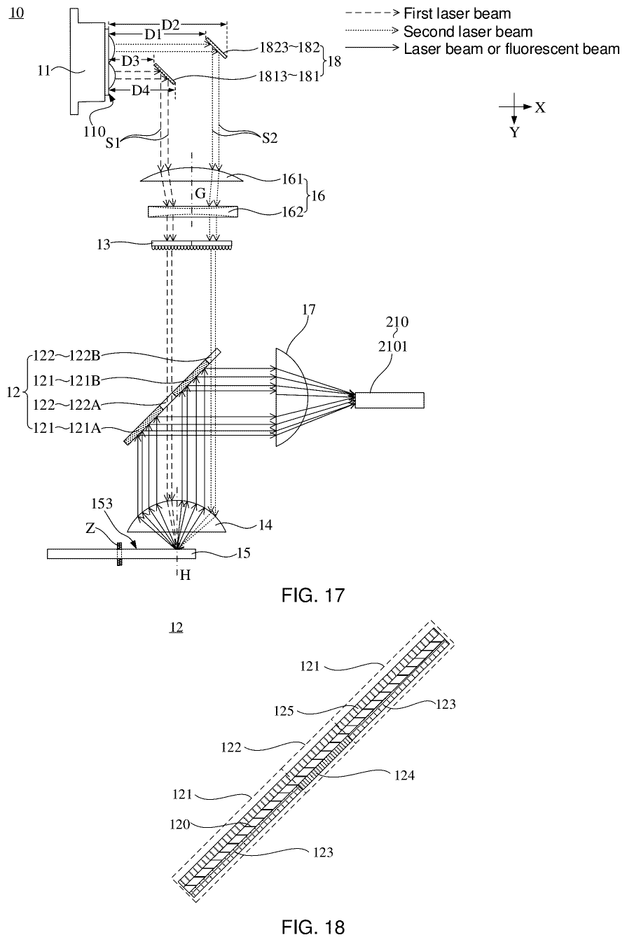

FIG. 17 is a diagram showing a structure of yet another laser source assembly, in accordance with some embodiments. Compared with FIG. 15, the laser-exit direction (e.g., the first direction X) of the laser device 11 in FIG. 17 is parallel to the laser-receiving surface 153 of the phosphor wheel 15.

In the above description, the mirror group 18 is mainly described by considering an example in which the laser-exit direction of the laser device 11 is perpendicular to the laser-receiving surface 153 of the phosphor wheel 15. However, in some embodiments, the laser-exit direction of the laser device 11 may also be parallel to the laser-receiving surface 153 of the phosphor wheel 15.

For example, as shown in FIG. 17, the first mirror sub-group 181 includes a fifth mirror 1813, and the second mirror sub-group 182 includes a sixth mirror 1823. The laser device 11 and the mirror group 18 are sequentially arranged in the first direction X, and the mirror group 18, the microlens array 13, the combining component 12, the first lens group 14, and the phosphor wheel 15 are sequentially arranged in the second direction Y.

The fifth mirror 1813 and the sixth mirror 1823 are configured to reflect different portions of the laser beams emitted by laser device 11, so as to form the first laser beam S1 and the second laser beam S2. The fifth mirror 1813 is closer to the laser-exit surface 110 of the laser device 11 than the sixth mirror 1823. The fifth mirror 1813 corresponds to the first transmitting region 122A, so as to reflect the incident laser beam to the first transmitting region 122A. The sixth mirror 1823 corresponds to the second transmitting region 122B, so as to reflect the incident laser beam to the second transmitting region 122B.

As shown in FIG. 17, the greater a distance between the fifth mirror 1813 and the sixth mirror 1823 in the first direction X, the greater a distance between the two laser beams obtained by splitting the laser beam by the fifth mirror 1813 and the sixth mirror 1823. In this way, the distance between the multiple laser beams exiting from the multiple mirrors may be adjusted by adjusting the distance between the multiple mirrors in the laser-exit direction of the laser device 11.

In some embodiments, a distance between each mirror and the laser-exit surface 110 of the laser device 11 includes a minimum distance between any point on a surface of the mirror proximate to the laser device 11 and the laser-exit surface 110 of the laser device 11. As shown in FIG. 17, a minimum distance D1 between the sixth mirror 1823 and the laser-exit surface 110 of the laser device 11 is greater than a maximum distance D4 between the fifth mirror 1813 and the laser-exit surface 110 of the laser device 11. In this way, a distance between any point on a surface of the sixth mirror 1823 proximate to the laser device 11 and the laser-exit surface 110 of the laser device 11 is greater than a distance between any point on a surface of the fifth mirror 1813 proximate to the laser device 11 and the laser-exit surface 110 of the laser device 11.

For example, as shown in FIG. 17, the minimum distance between the sixth mirror 1823 and the laser-exit surface 110 of the laser device 11 is D1, and a maximum distance between the sixth mirror 1823 and the laser-exit surface 110 of the laser device 11 is D2. A minimum distance between the fifth mirror 1813 and the laser-exit surface 110 of the laser device 11 is D3, and the maximum distance between the fifth mirror 1813 and the laser-exit surface 110 of the laser device 11 is D4. D1 is not equal to D3 and D4, and D4 is not equal to D1 and D2.

In some embodiments, in any two mirrors (e.g., the fifth mirror 1813 and the sixth mirror 1823), at least a portion of an orthogonal projection of a mirror on the laser-exit surface 110 of the laser device 11 is separated from at least a portion of an orthogonal projection of another mirror on the laser-exit surface 110 of the laser device 11.

In some embodiments, a surface of the mirror facing the laser-exit surface 110 of the laser device 11 is a reflective surface. For example, both surfaces of the mirror are reflective surfaces. Alternatively, the surface of the mirror facing the laser-exit surface 110 of the laser device 11 is the reflective surface.

FIG. 18 is a diagram showing a structure of yet another combining component, in accordance with some embodiments. Compared with FIG. 14, an anti-reflection film 125 is added to the combining component 12 in FIG. 18.

In some embodiments, as shown in FIG. 18, the combining component 12 further includes an anti-reflection film 125 disposed on the surface of the third substrate 120 proximate to the laser device 11, and the anti-reflection film 125 is configured to increase the transmissivity of the laser beam by the combining component 12. For example, the anti-reflection film 125 increases the transmissivity of the laser beam (e.g., the blue laser beam) emitted by the laser device 11. Alternatively, the anti-reflection film 125 may increase the transmissivity of the laser beam and fluorescent beam in all wavelengths.

In some embodiments, as shown in FIG. 18, the anti-reflection film 125 covers the surface of the third substrate 120 proximate to the laser device 11. Alternatively, the anti-reflection film 125 may also be disposed on a surface of the third substrate 120 located in the transmitting region 122. In this way, the loss of the laser beam may be reduced, and the utilization rate of the laser beam may be improved.

The first lens group 14 in some embodiments of the present disclosure is described in detail below.

As shown in FIGS. 8 and 15, the first lens group 14 is located between the combining component 12 and the phosphor wheel 15. The first lens group 14 is configured to converge the laser beams, so as to form a small beam spot on the laser-receiving surface 153 of the phosphor wheel 15. For example, the first lens group 14 is located on a side of the combining component 12 away from the microlens array 13. The first lens group 14 is further configured to collimate the laser beams reflected by the phosphor wheel 15 and the fluorescent beam emitted by the phosphor wheel 15 due to excitation of the laser beams, so that the laser beams reflected by the phosphor wheel 104 and the fluorescent beam emitted by the phosphor wheel 104 may be incident on the combining component 12 in a form of approximately parallel beam. The first lens group 14 includes a convex lens, and a convex arc surface of the convex lens protrudes toward the combining component 12.

In some embodiments, the first lens group 14 may include a plurality of convex lenses arranged in sequence along an arrangement direction of the combining component 12 and the phosphor wheel 15, and optical axes of the plurality of convex lenses are collinear. In this way, the laser beams incident on the first lens group 14 may be accurately converged on the phosphor wheel 15, and the laser beams reflected by the phosphor wheel 15 and the fluorescent beam emitted by the phosphor wheel 104 due to excitation may be accurately incident on the combining component 12.

In some examples, as shown in FIG. 15, the first lens group 14 includes a first convex lens 141 and a second convex lens 142. The first laser beam S1 and the second laser beam S2 are refracted at an angle and converged on the phosphor wheel 15 after passing through the first lens group 14.

For example, as shown in FIG. 15, a line connecting a position C of the first lens group 14, where the first laser beam S1 is incident on, and a position E of the phosphor wheel 15, where the first laser beam S1 is converged on, is a first line CE. An angle between the first line CE and the optical axis H of the first lens group 14 is an acute angle α. A line connecting a position D of the first lens group 14, where the second laser beam S2 is incident on, and the position E of the phosphor wheel 15, where the second laser beam S2 is converged on, is a second line DE. An angle between the second line DE and the optical axis H of the first lens group 14 is an acute angle β.

Since the first lens group 14 may collimate the laser beams reflected by the phosphor wheel 15 and the fluorescent beam emitted by the phosphor wheel 15, the laser beams and the fluorescent beam exiting from the phosphor wheel 15 may exit from the first lens group 14 and be incident on the combining component 12 in a form of approximately parallel beams after being incident on the first lens group 14 in a form similar to a Lambert body and collimated by the first lens group 14. It will be noted that the Lambert body may refer to a light-emitting object that may emit isotropic beams to the surroundings.

In some other embodiments, the first lens group 14 may also include one convex lens (as shown in FIG. 17).

The phosphor wheel 15 in some embodiments of the present disclosure will be described in detail below.

As shown in FIGS. 8 and 15, the phosphor wheel 15 is located on a side of the first lens group 14 away from the combining component 12 and configured to reflect the incident laser beams and be excited to emit the fluorescent beam due to irradiation of the incident laser beams.

FIG. 19 is a diagram showing a structure of a phosphor wheel, in accordance with some embodiments. For example, as shown in FIG. 19, the phosphor wheel 15 includes a laser region 151 and a fluorescent region 152. The laser region 151 and the fluorescent region 152 are enclosed to form a closed-loop (e.g., a ring). The laser region 151 is configured to reflect the incident laser beams. The fluorescent region 152 is configured to be excited to emit the fluorescent beam due to irradiation of the incident laser beams. It will be noted that a color of the fluorescent beam emitted by the phosphor wheel 15 is different from a color of the laser beams emitted by the laser device 11.

In some embodiments, as shown in FIGS. 8 and 19, the laser source assembly 10 further includes a rotating shaft Z. The phosphor wheel 15 may rotate around the rotating shaft Z. For example, the phosphor wheel 15 is in a shape of a ring. The rotating shaft Z is parallel to the second direction Y and passes through a center of the ring and is perpendicular to the laser-receiving surface 153 of the phosphor wheel 15. The phosphor wheel 15 may rotate around the rotating shaft Z in a direction W or an opposite direction of the direction W. During the rotation of the phosphor wheel 15, the laser beams from the combining component 12 may irradiate on different regions (e.g., the laser region 151 or the fluorescent region 152) of the phosphor wheel 15.

When the laser beams are incident on the laser region 151, the laser region 151 reflects the laser beams. The laser beams reflected by the laser region 151 are incident on the combining component 12 after passing through the first lens group 14. When the laser beams are incident on the fluorescent region 152, the fluorescent region 152 is excited to emit fluorescent beam by the laser beams. The fluorescent beam passes through the first lens group 14 and then is incident on the combining component 12. The reflecting region 121 of the combining component 12 reflects the incident laser beams and fluorescent beam to the light outlet of the laser source assembly 10 in the first direction X.

In some embodiments, the fluorescent region 152 may be provided with at least one of a green fluorescent material, a red fluorescent material, or a yellow fluorescent material. The fluorescent material may be phosphor. Each color of fluorescent material may emit a fluorescent beam of the corresponding color due to excitation of the laser beam. For example, the green fluorescent material may emit a green fluorescent beam due to excitation of the laser beam, the red fluorescent material may emit a red fluorescent beam due to excitation of the laser beam, and the yellow fluorescent material may emit a yellow fluorescent beam due to excitation of the laser beam.

In some embodiments, the fluorescent region 152 includes a fluorescent sub-region provided with a fluorescent material of one color.

In some embodiments, the fluorescent region 152 includes a plurality of fluorescent sub-regions provided with fluorescent materials of multiple colors, respectively. For example, as shown in FIG. 19, the fluorescent region 152 includes a first fluorescent sub-region 1521 and a second fluorescent sub-region 1522. One of the first fluorescent sub-region 1521 and the second fluorescent sub-region 1522 is provided with the red fluorescent material, and another one of the first fluorescent sub-region 1421 and the second fluorescent sub-region 1422 is provided with the green fluorescent material. In a case where the laser device 11 emits the blue laser beams, the laser region 151 may reflect the blue laser beams, and the first fluorescent sub-region 1521 and the second fluorescent sub-region 1522 are excited to emit the red fluorescent beam and the green fluorescent beam due to irradiation of the blue laser beams, respectively. In this way, the phosphor wheel 15 may emit the beams of three primary colors: red, green, and blue.

Some embodiments of the present disclosure are described by considering an example in which areas of the plurality of fluorescent sub-regions of the fluorescent region 152 are equal to each other, and an area of the laser region 151 is equal to the area of any one of the fluorescent sub-regions. Of course, the areas of the plurality of fluorescent sub-regions and the laser region 151 may also be different from each other, and the areas of the plurality of fluorescent sub-regions and the laser region 151 each may be designed according to a proportion of the laser beam or the fluorescent beam of the corresponding color in the white beams to be obtained.

For example, in a case where the laser device 11 emits the blue laser beams, the first fluorescent sub-region 1521 adopts the red fluorescent material, and the second fluorescent sub-region 1522 adopts the green fluorescent material. If the white beams may be obtained by combining the blue laser beam, the red fluorescent beam, and the green fluorescent beam in a ratio of 1:2:1, the area of the laser region 151 is equal to an area of the second fluorescent sub-region 1522, and the area of the second fluorescent sub-region 1522 is half of an area of the first fluorescent sub-region 1521. Of course, the color of the laser beams emitted by the laser device 11 and the fluorescent beam emitted by the phosphor wheel 15 due to excitation may also be other colors.

It will be noted that in a case where the laser chips in the laser device 11 emit laser beams at different times, the light-emitting durations of different laser chips may be determined according to the switching timing of the laser region 151 and the fluorescent region 152. For example, the laser beam emitted by the first laser chip is incident on the laser region 151, and the laser beam emitted by the second laser chip is incident on the fluorescent region 152. Moreover, the second laser chip may further include a plurality of laser sub-chips corresponding to the multiple fluorescent sub-regions in the fluorescent region 152. In this case, the number of the first laser chips and the second laser chips may be the same or different from each other.

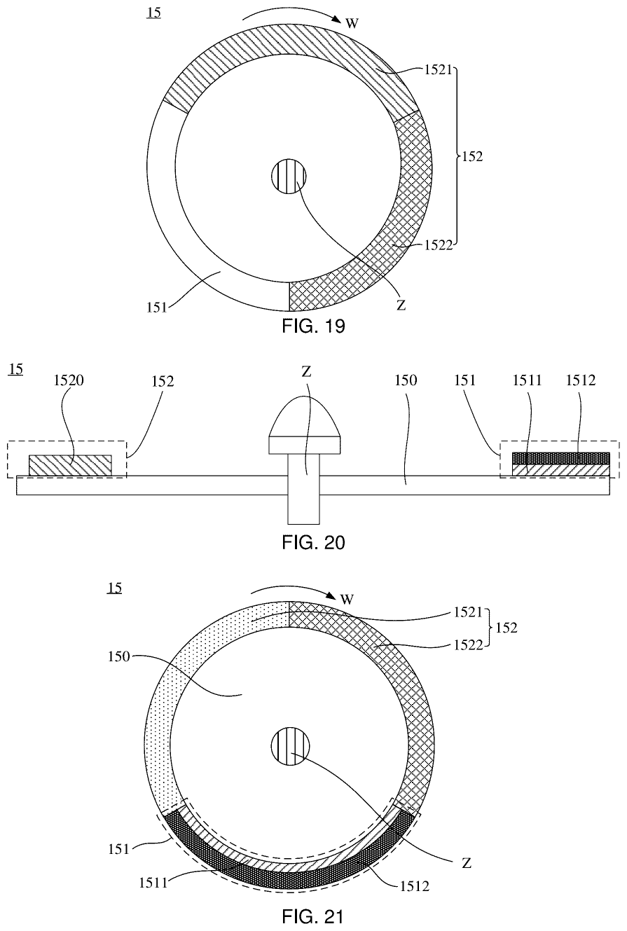

FIG. 20 is a diagram showing a structure of another phosphor wheel, in accordance with some embodiments.

In some embodiments, as shown in FIG. 20, the phosphor wheel 15 includes a second substrate 150. The second substrate 150 may be a reflective substrate. The laser region 151 and the fluorescent region 152 are each located on a surface of the reflective substrate proximate to the combining component 12. Since the fluorescent beam emitted by the fluorescent region 152 due to excitation exits in various directions in the form of a Lambert body, part of the fluorescent beam emitted by the fluorescent region 152 may be reflected to the combining component 12 by the reflective substrate, so that a light-emitting angle of the fluorescent region 152 may be substantially within a range of 0° to 180°, inclusive, thereby improving the utilization rate of fluorescent beam. Of course, a side of the phosphor wheel 15 away from the combining component 12 may also be opaque.

The fluorescent beam emitted by the fluorescent region 152 and the laser beams reflected by the laser region 151 may substantially cover an entire surface of the first lens group 14 proximate to the phosphor wheel 15. Therefore, the light (e.g., the laser beams or the fluorescent beam) exiting from the first lens group 14 to the combining component 12 may exit from an entire surface of the first lens group 14 proximate to the combining component 12.

A portion of the laser beams or the fluorescent beam collimated by the first lens group 14 may possibly be incident on the transmitting region 122 of the combining component 12. In this case, the combining component 12 may include a dichroic mirror or a dichroic film located in the transmitting region 122, so that the transmitting region 122 may reflect the fluorescent beam from the phosphor wheel 15 in the case of transmitting the laser beams emitted by the laser device 11, thereby improving the utilization rate of the fluorescent beam. Of course, in a case where the area of the transmitting region 122 is lesser, there is no need to provide a coating film, and the light loss caused by the fluorescent beam transmitted by the transmitting region 122 may also be reduced.

Generally, there is a difference between a wavelength of blue light received by the human eyes and a wavelength of the blue laser beams emitted by the laser device 11. For example, a color of the blue laser beams tends to be purple, so that the projection image formed by the blue laser beams may also tend to be purple, and the color of the projection image is uneven.

To solve the problem, in some embodiments, the laser region 151 is further configured to be excited to emit a second fluorescent beam due to irradiation of the incident laser beams. The second fluorescent beam is mixed with the laser beams reflected by the laser region 151, so as to adjust a wavelength range of the laser beams reflected by the laser region 151. For example, in a case where the laser device 11 emits the blue laser beams, the laser region 151 reflects the blue laser beams and is excited to emit the second fluorescent beam (e.g., the green fluorescent beam) due to irradiation of a portion of the blue laser beams, thereby changing the wavelength range of the blue laser beams reflected by the laser region 151.

It will be noted that the light exiting from the laser region 151 is the mixed light of the laser beams and the second fluorescent beam. Moreover, a wavelength range of the second fluorescent beam may be adjusted according to the required wavelength range of the laser beam. Here, the fluorescent beam emitted by the fluorescent region 152 of the phosphor wheel 15 may be referred to as a first fluorescent beam.

In this case, the transmitting region 122 may transmit light (e.g., the laser beams or the fluorescent beam) with the same color as the laser beams emitted by the laser device 11 and reflect light with a different color from the laser beams emitted by the laser device 11. For example, in a case where the laser device 11 emits the blue laser beams, the transmitting region 122 may transmit the blue light (i.e., the mixed light of the blue laser beams and the second fluorescent beam) blended by the laser region 151 and reflect the first fluorescent beam emitted by the fluorescent region 152 due to excitation. Of course, the transmitting region 122 may also reflect light of all colors that are different from the color of the laser beams emitted by the laser device 11. For example, the transmitting region 122 transmits the blue laser beams and reflects the fluorescent beam (e.g., the first fluorescent beam and the second fluorescent beam) of all other colors, so as to improve the utilization rate of light. Alternatively, the transmitting region 122 may further transmit light of all colors.

In some embodiments, as shown in FIG. 20, in addition to the second substrate 150, the phosphor wheel 15 further includes a first light adjusting portion 1511, a second light adjusting portion 1512, and a fluorescent portion 1520. The fluorescent portion 1520 is located in the fluorescent region 152 and configured to be excited to emit the first fluorescent beam due to irradiation of the incident laser beams. The first light adjusting portion 1511 and the second light adjusting portion 1512 are each located in the laser region 151, and the first light adjusting portion 1511 is closer to the second substrate 150 than the second light adjusting portion 1512. The first light adjusting portion 1511 is disposed on a surface of the second substrate 150 proximate to the combining component 12 and configured to be excited to emit the second fluorescent beam due to irradiation of the incident laser beams. At least a portion of the second light adjusting portion 1512 is disposed on a surface of the first light adjusting portion 1511 away from the second substrate 150, and the second light adjusting portion 1512 is configured to reflect the incident laser beams and transmit at least a portion of the incident laser beams.

Since the second light adjusting portion 1512 is located on a side of the first light adjusting portion 1511 away from the second substrate 150, when the laser beams transmitted by the combining component 12 are incident on the laser region 151, a first portion of the laser beams is reflected by the second light adjusting portion 1512, and a second portion of the laser beams is transmitted by the second light adjusting portion 1512 and is incident on the first light adjusting portion 1511, so as to excite the first light adjusting portion 1511 to emit the second fluorescent beam. The second fluorescent beam is mixed with the laser beams reflected by the second light adjusting portion 1512, so as to change the wavelength range of the laser beams reflected by the laser region 151.

In some embodiments of the present disclosure, the wavelength range of the laser beams reflected by the laser region 151 may be adjusted by providing the first light adjusting portion 1511 and the second light adjusting portion 1512 on the laser region 151 of the phosphor wheel 15, so that a dominant wavelength of the laser beams may be changed, thereby adjusting color purity of the illumination beams of the laser source assembly 10 and improving the display effect of the projection image. For example, in a case where the laser device 11 emits a blue laser beam of 455 nm, the dominant wavelength of the blue laser beam proximate to the wavelength range of the purple light may be adjusted, so as to improve color purity of the blue laser beam and solve the problem that the projection image tends to be purple.

It will be noted that a beam of light is produced by combining light of multiple wavelengths in a wavelength range. The beam of light perceived by the human eyes is a result of the combined action of the light of multiple wavelengths and corresponds to light of a single wavelength, and here the single wavelength is the dominant wavelength of the beam of light.

In some embodiments, by changing a ratio of the laser beam reflected by the second light adjusting portion 1512 to the laser beam transmitted by the second light adjusting portion 1512, a ratio of the laser beam reflected by the laser region 151 to the second fluorescent beam emitted by the laser region 151 may be adjusted.

For example, the second light adjusting portion 1512 includes a reflective film, and a ratio of the reflectivity of the reflective film to the transmissivity of the reflective film is greater than a first ratio. By changing the ratio of the reflectivity to the transmissivity of the reflective film, a ratio of the laser beam reflected by the reflective film to the second fluorescent beam emitted by the first light adjusting portion 1511 may be adjusted, so as to solve the color cast phenomenon of the laser beams emitted by the laser device 11. For example, a ratio of the blue laser beam reflected by the reflective film to the second fluorescent beam is greater than 3. The second light adjusting portion 1512 may include a reflective film, a dichroic film, or a film with a dividing light function such as a polarizing film.

Based on the structures of the first light adjusting portion 1511 and the second light adjusting portion 1512, the ratio of the laser beam reflected by the laser region 151 to the second fluorescent beam may be adjusted by increasing or reducing the type and number of films used in the second light adjusting portion 1512, which is conducive to adjusting the color of the mixed light.

Of course, the present disclosure is not limited thereto. FIG. 21 is a diagram showing a structure of yet another phosphor wheel, in accordance with some embodiments. Compared with FIG. 20, the first light adjusting portion 1511 and the second light adjusting portion 1512 in FIG. 21 are disposed on a surface of the second substrate 150.

In some embodiments, as shown in FIG. 21, the first light adjusting portion 1511 and the second light adjusting portion 1512 are each disposed on the surface of the second substrate 150 proximate to the combining component 12 and located in the laser region 151. The first light adjusting portion 1511 and the second light adjusting portion 1512 extend along a circumferential direction of the second substrate 150, and the first light adjusting portion 1511 is located on a side of the second light adjusting portion 1512 proximate to the rotating shaft Z. The first light adjusting portion 1511 is configured to be excited to emit the second fluorescent beam due to irradiation of the incident laser beams, and the second light adjusting portion 1512 is configured to reflect the incident laser beams.

As the phosphor wheel 15 rotates, a beam spot formed on the phosphor wheel 15 by the laser beams converged by the first lens group 14 irradiates on the laser region 151, and a first portion of the beam spot irradiates on the first light adjusting portion 1511, so as to excite the first light adjusting portion 1511 to emit the second fluorescent beam. A second portion of the beam spot irradiates on the second light adjusting portion 1512 and is reflected by the second light adjusting portion 1512.

It will be noted that in a case where the second substrate 150 is in a shape of a circle, since an edge of the second substrate 150 is in a shape of an arc, the first light adjusting portion 1511 and the second light adjusting portion 1512 are each also in a shape of an arc. Of course, in a case where the second substrate 150 has other shapes, the first light adjusting portion 1511 and the second light adjusting portion 1512 may also have other shapes, as long as the laser beams converged by the first lens group 14 may irradiate on the first light adjusting portion 1511 and the second light adjusting portion 1512 as the phosphor wheel 15 rotates.

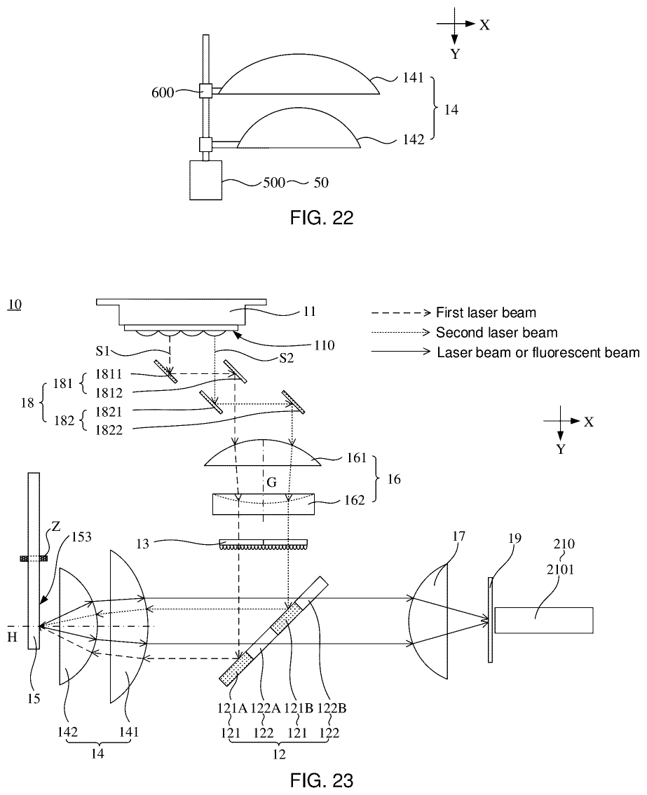

FIG. 22 is a diagram showing a structure of a driving component, in accordance with some embodiments.

In some embodiments, as shown in FIG. 22, the laser source assembly 10 further includes a driving component 50 configured to drive the first lens group 14 to move between the combining component 12 and the phosphor wheel 15 along at least one of the first direction X or the second direction Y, so as to adjust a size and position of the beam spot formed on the phosphor wheel 15 by the laser beams converged by the first lens group 14, thereby adjusting a ratio of areas of the beam spot irradiating on the first light adjusting portion 1511 and the second light adjusting portion 1512. In this way, the ratio of the laser beam reflected by the laser region 151 and the second fluorescent beam emitted by the laser region 151 may be adjusted, which is conducive to adjusting the wavelength range of the laser beams reflected by the laser region 151.

For example, the driving component 50 includes a driving motor 500. A rotating shaft of the driving motor 500 is connected to a fixing bracket 600 of the first lens group 14. In this way, the driving motor 500 may drive the first lens group 14 to move in a direction parallel to the second direction Y, so as to adjust the size of the beam spot formed on the phosphor wheel 15 by the laser beams converged by the first lens group 14.

FIG. 22 illustrates an example in which the driving motor 500 drives the first lens group 14 to move in the direction parallel to the second direction Y. It can be understood that the first lens group 14 may also be moved along the first direction X by adjusting the position of the driving motor 500, so as to adjust a distance between the beam spot formed on the phosphor wheel 15 by the laser beams converged by the first lens group 14 and a center of the second substrate 150, so that the ratio of the areas of the beam spot irradiating on the first light adjusting portion 1511 and the second light adjusting portion 1512 may be adjusted.

Of course, the first lens group 14 may also be driven to move by other ways. For example, a cylinder drives the first lens group 14 to move, or a ball screw mechanism drives the first lens group 14 to move. The present disclosure is not limited thereto.

In some embodiments of the present disclosure, the loss of the laser beams may be reduced, and the utilization rate of the laser beams may be improved by making the laser beams converged by the first lens group 14 incident on the first light adjusting portion 1511 and the second light adjusting portion 1512. Moreover, the ratio of the areas of the beam spot irradiating on the first light adjusting portion 1511 and the second light adjusting portion 1512 may be adjusted by adjusting the position of the first lens group 14, so that there is no need to adjust the structures of the first light adjusting portion 1511 and the second light adjusting portion 1512, which is conducive to adjusting the wavelength range of the laser beams reflected by the laser region 151.

In some embodiments, as shown in FIG. 15, the laser source assembly 10 further includes a second lens group 16 located between the laser device 11 and the microlens array 13 and configured to contract a beam spot of the incident laser beam. The second lens group 16 may make a beam of the laser beam exiting from the second lens group 16 thinner than a beam of the laser beam incident on the second lens group 16. It will be noted that, although the second lens group 16 is shown in FIG. 15, in some embodiments, the second lens group 16 may be omitted.

In some embodiments, the second lens group 16 includes a first sub-lens 161 and a second sub-lens 162. The first sub-lens 161 is a convex lens, and the second sub-lens 162 is a concave lens. The first sub-lens 161 and the second sub-lens 162 are sequentially arranged along the second direction Y. In this way, the second lens group 16 may first converge the laser beams emitted by the light-emitting assembly 101 and then diverge the converged laser beams. The laser beams may still exit from the second lens group 16 in the form of approximately parallel beams in a case where the laser beams emitted by the laser device 11 are incident on the second lens group 16 in the form of approximately parallel beams. Moreover, the laser beams incident on the combining component 12 are parallel to the laser-exit direction (e.g., the second direction Y) of the laser device 11. For example, the second lens group 16 is a telescope system with a high magnification, which may contract the laser beams to a great extent.

It will be noted that an optical axis G of the second lens group 16 and the optical axis H of the first lens group 14 may be non-collinear. In this way, the plurality of laser beams emitted by the laser device 11 may be symmetrical with respect to the optical axis G of the second lens group 16, so that the second lens group 16 may contract the plurality of laser beams to a same extent. Alternatively, the optical axis G of the second lens group 16 and the optical axis H of the first lens group 14 may be collinear.

The second lens group 16 may make a beam of the laser beam exiting from the second lens group 16 thinner than a beam of the laser beam incident on the second lens group 16. Therefore, sizes of the microlens array 13 and the transmitting region 122 may be reduced, which is conducive to reducing a volume of the combining component 12 and facilitates the miniaturization of the laser source assembly 10.

In some embodiments, as shown in FIG. 8, the laser source assembly 10 further includes a third lens group 17. The combining component 12 and the third lens group 17 are sequentially arranged along the first direction X. The third lens group 17 is located on a laser-exit side of the combining component 12 and configured to converge the laser beams and the fluorescent beam reflected by the combining component 12 and propagate the converged laser beams and fluorescent beam to the light pipe 2101 through the light outlet of the laser source assembly 10. It will be noted that FIG. 8 illustrates an example in which the third lens group 17 includes one lens. However, the third lens group 17 may also include a plurality of lenses, and the present disclosure is not limited thereto.

In some embodiments, the third lens group 17 may be a convex lens with good symmetry, so as to uniformly change the divergence angles of the incident laser beam or fluorescent beam in all directions. For example, the third lens group 17 reduces the divergence angles of the incident laser beam or fluorescent beam in all directions by a same angle (e.g., 3°), so as to reduce differences between the divergence angles of the laser beam or fluorescent beam passing through the third lens group 17 in different directions.

In some embodiments, as shown in FIG. 15, the laser source assembly 10 further includes a filter wheel 19 disposed on a laser-exit side of the third lens group 17 and configured to filter the incident laser beams and the incident fluorescent beam, so as to improve saturation of colors of the illumination beams exiting from the laser source assembly 10, thereby improving the display effect of the projection image.

The above description is mainly given by considering an example in which the first lens group 14 and the phosphor wheel 15 are disposed on a side of the combining component 12 away from the laser device 11, and an arrangement direction of the first lens group 14 and the phosphor wheel 15 is perpendicular to the first direction X. Of course, the present disclosure is not limited thereto.

FIG. 23 is a diagram showing a structure of yet another laser source assembly, in accordance with some embodiments. Compared with FIG. 15, an arrangement direction of the first lens group 14 and the phosphor wheel 15 in FIG. 23 is parallel to the first direction X.

In some embodiments, as shown in FIG. 23, the first lens group 14 and the phosphor wheel 15 are each disposed on a side of the combining component 12 away from the third lens group 17. The phosphor wheel 15, the first lens group 14, and the combining component 12 are sequentially arranged along the first direction X. The laser beams split by the mirror group 18 are incident on the plurality of reflecting regions 121, respectively, and then reflected to the first lens group 14 by the plurality of reflecting regions 121.

The laser beams reflected by the plurality of reflecting regions 121 are converged onto the phosphor wheel 15 by the first lens group 14. The laser beams incident on the phosphor wheel 15 are reflected to the first lens group 14 by the phosphor wheel 15. Alternatively, the laser beams incident on the phosphor wheel 15 excite the phosphor wheel 15 to emit the fluorescent beam, and the fluorescent beam is incident on the first lens group 14. The first lens group 14 collimates the laser beams and the fluorescent beam from the phosphor wheel 15 into parallel beams, and then the collimated laser beams and fluorescent beam are incident on the combining component 12. The laser beams and fluorescent beam incident on the combining component 12 are transmitted by the plurality of transmitting regions 122 in the combining component 12 and are then incident on the light outlet of the laser source assembly 10, so as to be used to display the projection image.

It will be noted that, in this case, the laser beams split by the mirror group 18 are arranged correspondingly to the plurality of reflecting regions 121 in the combining component 12, and details will not be repeated herein.

In the above description of the embodiments, specific features, structures, materials, or characteristics may be combined in a suitable manner in any one or more embodiments or examples.

A person skilled in the art will understand that the scope of disclosure in the present disclosure is not limited to specific embodiments discussed above and may modify and substitute some elements of the embodiments without departing from the spirits of the present disclosure. The scope of the present disclosure is limited by the appended claims.

What is claimed is:

1. A laser projection apparatus, comprising:
a laser source assembly configured to provide illumination beams;
a light modulation assembly configured to modulate the illumination beams, so as to obtain projection beams; the light modulation assembly including a light pipe configured to receive the illumination beams provided by the laser source assembly and homogenize the illumination beams, a light inlet of the light pipe being in a shape of a rectangle; and
a projection lens configured to project the projection beams into an image;
wherein the laser source assembly includes:
a laser device configured to emit a plurality of laser beams;
a microlens array located on a laser-exit side of the laser device and configured to increase divergence angles of the plurality of laser beams in a slow axis direction and a fast axis direction, so as to make a ratio of a divergence angle of the laser beams diverged by the microlens array in the slow axis direction to a divergence angle of the laser beams diverged by the microlens array in the fast axis direction be proportional to a length-width ratio of the light inlet of the light pipe; an angle at which the microlens array diffuses the incident laser beams in the fast axis direction being different from an angle at which the microlens array diffuses the incident laser beams in the slow axis direction; the microlens array including a first substrate and a plurality of microlenses arranged in an array on the first substrate;
a combining component located on a side of the microlens array away from the laser device, the combining component being configured to reflect laser beams and a fluorescent beam exiting from a phosphor wheel and transmit the plurality of laser beams emitted by the laser device; and
the phosphor wheel located on a side of the combining component away from the microlens array, the phosphor wheel being configured to reflect the laser beams transmitted by the combining component and be excited to emit the fluorescent beam due to irradiation of the laser beams;
wherein the laser beams reflected by the phosphor wheel and the fluorescent beam emitting by the phosphor wheel are incident on the combining component and reflected to the light inlet of the light pipe by the combining component, and the laser beams and the fluorescent beam incident on the light pipe constitute the illumination beams.

2. The laser projection apparatus according to claim 1, wherein
the laser device includes a collimating lens group disposed on a laser-exit surface of the laser device and configured to collimate the plurality of laser beams emitted by the laser device, and a divergence angle of the laser beams collimated by the collimating lens group in the slow axis direction is greater than a divergence angle of the laser beams collimated by the collimating lens group in the fast axis direction; and
an angle at which at least one of the plurality of microlenses diffuses the laser beam in the slow axis direction is greater than an angle at which the at least one microlens diffuses the laser beam in the fast axis direction.

3. The laser projection apparatus according to claim 1, wherein an orthogonal projection of the at least one of the plurality of microlenses on the first substrate is in a shape of a rectangle, and an angle at which the at least one microlens diffuses the laser beam in a long side of the at least one microlens is greater than an angle at which the at least one microlens diffuses the laser beam in a short side direction of the at least one microlens.

4. The laser projection apparatus according to claim 3, wherein a ratio of the angle at which the microlens diffuses the laser beam in the long side of the microlens to the angle at which the microlens diffuses the laser beam in the short side direction of the microlens is greater than or equal to 1.7.

5. The laser projection apparatus according to claim 4, wherein an angle at which the microlens diffuses the laser beam in the slow axis direction is greater than or equal to 0.5°.

6. The laser projection apparatus according to claim 1, wherein the microlens array satisfies one of following:
the microlens array includes a single-sided microlens array, and a radius of a curved surface of at least one of the plurality of microlenses is equal to a first preset value; and
the microlens array includes a double-sided microlens array, the plurality of microlenses have a same size, a radius of a curved surface of at least one of the plurality of microlenses is equal to a second preset value, and a ratio of the second preset value to the first preset value is greater than or equal to 1.8 and less than or equal to 2.3.

7. The laser projection apparatus according to claim 1, wherein
the plurality of laser beams emitted by the laser device provide a plurality of first beam spots on the microlens array, and each of the plurality of first beam spots includes:
a first region; and
a second region surrounding the first region;
the plurality of microlenses include:
a plurality of first microlenses disposed on the first substrate, the plurality of first microlenses constituting a first homogenizing light region overlapping with the first region of the first beam spot; and
a plurality of second microlenses disposed on the first substrate, the plurality of second microlenses constituting a second homogenizing light region overlapping with the second region of the first beam spot;
wherein an ability of the first microlens of the plurality of first microlenses for homogenizing light is higher than an ability of the second microlens of the plurality of second microlenses for homogenizing light.

8. The laser projection apparatus according to claim 7, wherein a size of the first microlens is less than a size of the second microlens.

9. The laser projection apparatus according to claim 7, wherein in a direction from a center of the first beam spot to an edge of the first beam spot, the size of at least one of the plurality of first microlenses or the plurality of second microlenses increases.

10. The laser projection apparatus according to claim 7, wherein an angle at which the plurality of first microlenses diffuse the incident laser beam is greater than an angle at which the plurality of second microlenses diffuse the incident laser beam, and the angle at which each of the plurality of microlenses diffuses the incident laser beam is related to a focal length of each of the microlenses or a length-width ratio of a rectangular laser-receiving surface of each of the microlenses.

11. The laser projection apparatus according to claim 7, wherein the microlens array further includes a diffusion layer disposed on a surface of the first substrate and configured to homogenize the incident laser beam, on a plane where the first substrate is located, an orthogonal projection of the diffusion layer at least covers orthogonal projections of the plurality of first microlenses.

12. The laser projection apparatus according to claim 1, wherein the laser source assembly further includes a first lens group, and the first lens group is located between the combining component and the phosphor wheel and configured to converge the plurality of laser beams transmitted by the combining component to the phosphor wheel.

13. The laser projection apparatus according to claim 12, wherein the phosphor wheel includes:
a fluorescent region configured to be excited to emit a first fluorescent beam due to irradiation of the incident laser beam; and
a laser region configured to reflect the incident laser beam and be excited to emit a second fluorescent beam due to irradiation of the incident laser beam, so that the second fluorescent beam is mixed with the laser beam reflected by the laser region to adjust a wavelength range of the laser beam reflected by the laser region.

14. The laser projection apparatus according to claim 13, wherein the phosphor wheel satisfies one of following:
the phosphor wheel further includes:
a second substrate, the fluorescent region and the laser region each being located on a surface of the second substrate proximate to the combining component, and the fluorescent region and the laser region being enclosed to constitute a closed-loop;
a first light adjusting portion disposed on the surface of the second substrate proximate to the combining component and located in the laser region, the first light adjusting portion being configured to be excited to emit the second fluorescent beam due to irradiation of the incident laser beam; and
a second light adjusting portion located in the laser region, at least a portion of the second light adjusting portion being disposed on a surface of the first light adjusting portion away from the second substrate, and the second light adjusting portion being configured to reflect the incident laser beam and transmit at least a portion of the incident laser beam; and
the phosphor wheel further includes:
the second substrate, the fluorescent region and the laser region being each located on a surface of the second substrate proximate to the combining component, and the fluorescent region and the laser region being enclosed to constitute a closed-loop;
the first light adjusting portion disposed on the surface of the second substrate proximate to the combining component and located in the laser region, and the first light adjusting portion being configured to be excited to emit the second fluorescent beam due to irradiation of the incident laser beam; and
the second light adjusting portion disposed on the surface of the second substrate proximate to the combining component and located in the laser region, and the second light adjusting portion being located on a side of the first light adjusting portion and configured to reflect the incident laser beam.

15. The laser projection apparatus according to claim 13, wherein the laser beams emitted by the laser device are blue laser beams, and the second fluorescent beam is a green fluorescent beam.

16. The laser projection apparatus according to claim 12, wherein the laser source assembly further includes a driving component configured to drive the first lens group to move between the combining component and the phosphor wheel along at least one of a first direction or a second direction, so as to adjust a size and a position of a beam spot provided on the phosphor wheel by the laser beams converged by the first lens group, so as to adjust a ratio of areas of the beam spot irradiating on a first light adjusting portion and a second light adjusting portion;
wherein the second direction is parallel to an arrangement direction of the phosphor wheel and the first lens group, and the first direction is perpendicular to the second direction.

17. The laser projection apparatus according to claim 12, wherein the combining component is disposed obliquely with respect to a laser-exit direction of the laser device, and the combining component includes:
a plurality of reflecting regions configured to reflect the laser beams and the fluorescent beam exiting from the phosphor wheel; and
a plurality of transmitting regions configured to transmit the plurality of laser beams emitted by the laser device, the plurality of reflecting regions and the plurality of transmitting regions being alternately arranged;
wherein beam spots produced on the first lens group by any two laser beams among the plurality of laser beams incident on the plurality of transmitting regions are asymmetrical with respect to an optical axis of the first lens group.

18. The laser projection apparatus according to claim 17, wherein
the laser device is configured to emit a first laser beam and a second laser beam;
the plurality of reflecting regions include a first reflecting region and a second reflecting region, and the plurality of transmitting regions include a first transmitting region and a second transmitting region, the first reflecting region, the first transmitting region, the second reflecting region, and the second transmitting region are alternately arranged in sequence, the first reflecting region is proximate to the phosphor wheel, and the second transmitting region is proximate to the laser device;
wherein the first laser beam is transmitted to the first lens group by the first transmitting region, and the second laser beam is transmitted to the first lens group by the second transmitting region.

19. The laser projection apparatus according to claim 1, wherein the laser source assembly further includes:
a second lens group located between the microlens array and the laser device and configured to contract a beam spot of the incident laser beam;
a third lens group located on a laser-exit side of the combining component and configured to converge the laser beams and the fluorescent beam reflected by the combining component; and
a filter wheel located on a laser-exit side of the third lens group and configured to filter the incident laser beams and the fluorescent beam.

20. A laser projection apparatus, comprising:
a laser source assembly configured to provide illumination beams;
a light modulation assembly configured to modulate the illumination beams, so as to obtain projection beams; the light modulation assembly including a light pipe configured to receive the illumination beams provided by the laser source assembly and homogenize the illumination beams, a light inlet of the light pipe being in a shape of a rectangle; and
a projection lens configured to project the projection beams into an image;
wherein the laser source assembly includes:
a laser device configured to emit a plurality of laser beams;
a microlens array located on a laser-exit side of the laser device and configured to increase divergence angles of the plurality of laser beams in a slow axis direction and a fast axis direction, so as to make a ratio of a divergence angle of the laser beams diverged by the microlens array in the slow axis direction to a divergence angle of the laser beams diverged by the microlens array in the fast axis direction be proportional to a length-width ratio of the light inlet of the light pipe; an angle at which the microlens array diffuses the incident laser beams in the fast axis direction being different from an angle at which the microlens array diffuses the incident laser beams in the slow axis direction; the microlens array including a first substrate and a plurality of microlenses arranged in an array on the first substrate;
a combining component located on a side of the microlens array away from the laser device, the combining component being configured to reflect the plurality of laser beams emitted by the laser device and transmit laser beams and a fluorescent beam exiting from a phosphor wheel; and
the phosphor wheel located on a side of the combining component, an arrangement direction of the phosphor wheel and the combining component being perpendicular to an arrangement direction of the microlens array and the combining component, the phosphor wheel being configured to reflect the laser beams reflected by the combining component and be excited to emit the fluorescent beam due to irradiation of the laser beams;
wherein the laser beams reflected by the phosphor wheel and the fluorescent beam emitted by the phosphor wheel are incident on the combining component and transmitted to the light inlet of the light pipe by the combining component, and the laser beams and the fluorescent beam incident on the light pipe constitute the illumination beams.
